(19) United States
(12) Patent Application Publication
(10) Pub. No.: US 2024/0224838 A1
(43) Pub. Date: Jul. 11, 2024

(54) METHOD AND APPARATUS FOR GENERATING CLUSTER CONTOURS AND CURVED TRACKS AND FOR IMPROVING FARMING EFFICIENCY

(71) Applicant: Verge Technologies IP Corp., Lethbridge (CA)

(72) Inventors: Godard ., Calgary (CA); Nicholas Morrow, Sioux Falls, SD (US); Yussef Akl, Calgary (CA); Chad Matthies, La Salle (CA); Muhammad Ali Khan, Calgary (CA); Anaïs Rojas, Vancouver (CA)

(73) Assignee: Verge Technologies IP Corp., Lethbridge, AB (CA)

(21) Appl. No.: 18/407,862

(22) Filed: Jan. 9, 2024

Related U.S. Application Data
(60) Provisional application No. 63/437,974, filed on Jan. 9, 2023.
(60) Provisional application No. 63/530,603, filed on Aug. 3, 2023.

(51) Int. Cl. A01C 21/00; A01B 79/00; A01B 79/02; G06T 7/13; G06V 10/44; G06V 10/762; G06V 20/10; G06V 20/13

(52) U.S. Cl. CPC A01C 21/005; A01B 79/005; A01B 79/02; G06T 7/13; G06V 10/44; G06V 10/762; G06V 20/13; G06V 20/188; G06T 2207/10032; G06T 2207/30188

(57) ABSTRACT

A method and apparatus for evaluating farming equipment with respect to geographic details for a field on which the equipment will be operated without requiring the equipment to be purchased and/or taken to the actual field. Specifications about equipment can be retrieved from a database of equipment and used for creating a path plan for an agricultural field. Optionally, the path plan can be created based in part on a longest straight edge of the agricultural filed and/or by clustering of elevation contours such that the path plan is arranged whereby a group of similar elevations are traversed before a group of other similar elevations are traversed.

### CROSS-REFERENCE TO RELATED APPLICATIONS

This application claims priority to and the benefit of the filing of U.S. Provisional Patent Application No. 63/437,974, entitled “Method and Apparatus for Improving Farming Efficiency”, filed on Jan. 9, 2023, and the specification and claims thereof are incorporated herein by reference. This application also claims priority to and the benefit of the filing of U.S. Provisional Patent Application No. 63/530,603, entitled “Method and Apparatus for Generating Cluster Contours and Curved Tracks”, filed on Aug. 3, 2023, and the specification and claims thereof are incorporated herein by reference.

### STATEMENT REGARDING FEDERALLY SPONSORED RESEARCH OR DEVELOPMENT

Not Applicable.

### BACKGROUND OF THE INVENTION

Embodiments of the present invention relate to improving the efficiency of farming operations. More particularly, embodiments of the present invention improve farming efficiency by enabling farmers to predictively plan and model precise farming operations for a particular plot of land with each piece of equipment that will be needed before ever planting the first seed. Embodiments of the present invention also enable farmers to predictively model different types of equipment and implements on the very fields that the farmer works to accurately determine potential savings in time, money, and/or fuel for any one or more steps of a farming operation, without the need to actually use the equipment on the plot of land to determine the result.

While other modern farming operations that rely on GPS navigation have greatly improved the efficiency of farming operations there is still a great deal of waste that occurs. The amount of waste is especially significant due to the ever-increasing size of modern farming operations. Such waste occurs from trampling crops that have already been planted during spraying applications, wasting fertilizers or herbicides which are needlessly applied at double doses at various locations and the damage that can occur to crops when such double doses are applied.

As used throughout this application, the term “equipment” is intended to include any and all power units, implements, and any other device or apparatus that may be driven, operated, pulled, towed, or otherwise caused to travel across a field. Part of the difficulty in avoiding waste time, money, and/or resources during a complete farming operation is because there are so many different options for equipment that a farmer can use—including not only different makes and models of equipment, but also different sizes, configurations, or other specifications. For example, one sprayer from a first manufacturer may have a tire width of 12 inches and a wheel spacing of 10 feet while another manufacturer may sell a sprayer of substantially the same size, but it has a tire width of 15 inches and a wheel spacing of 11 feet. Therefore, during a spraying operation with such units, one sprayer will trample crops in an area that is slightly different from the other unit. In addition, while one power unit may have a turning radius of 10 feet when a particular sprayer is connected behind it, the turning radius may be increased to 18 feet for a first sprayer or to 20 feet with a second sprayer; while a harvester that the framer plans to use on that crop may have a turn radius of 15 feet. Thus, not only does the size of the turn radius at the end of every row change depending on what is being towed (and thus potentially the most efficient crop planting layout), but also the area trampled by the power unit, harvester, or anything else being towed or driven. Such trampled crop areas are wasted because the farmer worked the land there, planted the crop, then potentially watered the crop before subsequently trampling over it with a sprayer and thus destroying it. This results in wasted time, wasted seed, and other wasted resources. There is thus a present need for a method and apparatus that enables farmers to accurately predict future farming operations to such a degree that the farmer can know where their tires will travel during not only crop planting, but also during subsequent crop maintenance and/or harvesting procedures. U.S. Pat. Nos. 9,933,787 and 10,740,703 teach background information related to this invention. Those patents are incorporated herein by reference.

Farming operations in regions with irregular terrain require careful path planning to ensure full coverage, reduced costs and minimize soil erosion, while making the machine path steerable. Going uphill or downhill, unchecked, erodes the soil and increases the three-dimensional (“3D”) distance traveled by the machine. This increases short-term and long-term costs for the growers as well as raising serious sustainability issues. As a result, growers not only want to use elevation features for path planning but also use them for designing, redesigning and partitioning their fields.

Today, growers have the option of employing off-the-shelf (“OTS”) elevation data and contour lines in path planning. However, this requires geographic information systems (“GIS”) analysts, agricultural consultants and technicians proficient in computer aided design (“CAD”), software to analyze the terrain, and produce steerable contour lines. The problem of growers executing this in real-time directly through a web application (“app”) remains open.

There is another issue that has been neglected in the industry. In the domain of GIS, a contour is defined as a line joining points of a raster dataset that are at the same elevation. There are several OTS sources of contours that provide lines at 10 meters (“m”) elevation intervals (for example at 0 m, 10 m, 20 m, etc.). These lines provide a good sense of the general terrain in the region but are not suitable for field design or path planning. Instead of GIS contours, there is a present need to determine lines that separate parts of the field that significantly differ in elevation while points in each part have similar elevations. For example, find a line such that all or most of the raster datapoints on one side have elevations between 0-10 m while the points on the other side have elevations between 20-30 m. These lines can then be used to either partition (for example for field design) and/or path plan the field. From here on, we refer to traditional GIS contours as single-elevation contours (“SECs”) and the lines separating different elevation regions as cluster contours (“CCs”) also referred to herein as elevation boundaries (“EBs”)—because they will be generated using a clustering algorithm according to an embodiment of the present invention and because they bound regions with different elevations.

### BRIEF SUMMARY OF EMBODIMENTS OF THE PRESENT INVENTION

Embodiments of the present invention are directed to a method for evaluating farming equipment on a physically tangible agricultural field without requiring a user to actually operate the equipment on the physically tangible agricultural field, the method preferably includes providing field data representing actual geographic conditions for the physically tangible agricultural field on which a farming operation is to be performed, providing specifications of existing farming equipment, using the provided specifications and the provided field data to determine a first optimized path plan for the existing farming equipment on the physically tangible agricultural field, retrieving specifications for at least one piece of other farming equipment from an equipment database, using the retrieved specifications and the field data to determine a second optimized path plan for the at least one piece of other farming equipment on the physically tangible agricultural field, calculating at least one of optimized path distance and optimized path travel time for the existing equipment on the first optimized path plan, calculating at least one of optimized path distance and optimized path travel time for the at least one piece of other farming equipment, and reporting results of a comparison between at least one of the optimized path travel time for the existing equipment and the at least one piece of other farming equipment, and the optimized path distance for the existing equipment and the at least one piece of other farming equipment.

Optionally, providing field data can include providing field data representing at least a shape and size of the physically tangible agricultural filed. Providing field data can include providing data from a satellite image of the physically tangible agricultural field. Providing specifications of existing farming equipment can include selecting at least some of the existing farming equipment from the equipment database. In the method, retrieving specifications can itself include retrieving specifications for at least some portion of the existing farming equipment. The method can also include adjusting performance characteristics for the at least some portion of the existing farming equipment based on the retrieved specifications for the at least one piece of other farming equipment.

Embodiments of the present invention also relate to a farming method for a physically tangible agricultural field, the method including obtaining data representing at least a boundary of the physically tangible agricultural field, extracting line segments from boundary polygons of the obtained data, computing headings for the extracted line segments, clustering the line segments into a plurality of clusters based on the computed headings, ranking the plurality of clusters based on total length of line segments contained in each cluster, and reporting a heading for farming equipment to use to perform a farming operation, the heading associated with a line of best fit for a cluster having a largest total length of line segments. Clustering the line segments according to the computed headings can itself include clustering the line segments according to computed headings with a heading threshold such that each line segment in a cluster need not have numerically identical heading values. The heading threshold can optionally be user-defined. The margin of error can optionally be such that line segments within a cluster have headings that differ from one another by not more than about 3 degrees. Reporting a heading associated with line segments can include reporting a heading that is an average of headings for all line segments for the cluster having the largest total length of line segments. The method can also include causing farming equipment to travel in a heading that is at least substantially equal to a heading of at least one of the line segments contained in the cluster having the largest total length of line segments. The method can also include causing a piece of farming equipment to travel in a heading that is at least substantially equal to a heading of at least one of the line segments contained in the cluster having the largest total length of line segments to perform a farming operating.

In one embodiment, the method can also include reporting a heading associated with line segments for a cluster having a second largest total length of line segments and/or selecting a heading associated with either the cluster having the largest total length of line segments or a heading associated with a cluster having a second largest total length of line segments and using the selected heading for planning a path for a farming equipment. The method can also include dividing at least some of the plurality clusters into a plurality of smaller clusters based on a distance threshold. Reporting a heading associated with line segments can include calculating a regression line or line of best fit for line segments in the cluster having the largest total length of line segments. The method can include generating a path plan for the physically tangible agricultural field based at least in part on a multi-line string that includes a plurality of parallel line strings having a heading that at least substantially corresponds with the reported heading. In one embodiment, generating a path plan for the physically tangible agricultural field can include obtaining as inputs at least one of specifications of the agricultural equipment, obtaining a number of perimeter passes inside an exterior boundary of the physically tangible agricultural field, and avoiding boundaries of obstacles that are disposed at least partially within a perimeter of the physically tangible agricultural field. Optionally, obtaining data representing at least a boundary of a physically tangible agricultural field can include obtaining satellite image data of the physically tangible agricultural field.

Embodiments of the present invention also relate to a farming method for a physically tangible agricultural field that includes obtaining raster data representing at least a boundary of the physically tangible agricultural field; clustering elevation data into a plurality of different clusters; creating cluster contour lines between the plurality of different clusters by detecting and extracting the cluster contour lines; ranking the created cluster contour lines based on at least one of length, maximum gradient along a length of the respective cluster contour line, and maximum gradient on opposing sides of the respective cluster contour line; selecting at least one of the cluster contour lines from the ranked cluster contour lines; generating tracks by offsetting each of the smoothed selected at least one cluster contour lines; smoothing the generated tracks to maintain steerability of the farming equipment when operating on the physically tangible agricultural field; and performing slope-distance analysis on the smoothed tracks to estimate at least one of anticipated soil erosion that will be caused by the farming equipment when operating on the physically tangible agricultural field; and distance that will be traveled by the farming equipment when operating on the physically tangible agricultural field.

The method can also include partitioning the physically tangible agricultural field into at least a first subfield and a second subfield based on at least one top-ranking cluster contour and generating a first path plan for the first subfield and generating a second path plan for the second subfield. The method can also include cropping the contours along a boundary of the physically tangible agricultural field and/or upsampling the raster data by interpolation. Upsampling the raster data by interpolation can include upsampling the raster data by cubic spline interpolation. In the method, detecting and extracting the cluster contour lines can include using a machine vision algorithm, which can optionally be a Canny edge detection algorithm. In one embodiment, after extraction and prior to ranking, the cluster contour lines are cleaned to remove zig-zag and chain-line features by smoothing the contour lines along such features. Optionally, soothing the cluster contour lines along such features can include simplifying the cluster contour lines along such features by using a topology-preserving Douglas-Peucker simplification and then smoothing the cluster contour lines using a Taubin non-shrinking polyline smoothing function.

The method can also include splitting cluster contour lines that are closed loops or have at least 270 degrees of closure. Selecting at least one of the cluster contour lines can include selecting at least one cluster contour line having a ranking that places it in the top 10% of ranked cluster contour lines. Generating tracks by offsetting each of the selected at least one cluster contour lines can include generating tracks by offsetting each of the selected at least one cluster contour lines after the selected at least one cluster contour lines have first been smoothed.

Embodiments of the present invention also relate to a farming method for a physically tangible agricultural field that includes providing field data representing actual geographic conditions for the physically tangible field on which a farming operation is to be performed that includes obtaining raster data representing at least a boundary of the physically tangible agricultural field; clustering elevation data into a plurality of different clusters; creating cluster contour lines between the plurality of different clusters by detecting and extracting the cluster contour lines; ranking the created cluster contour lines based on at least one of length, maximum gradient along a length of the respective cluster contour line, and maximum gradient on opposing sides of the respective cluster contour line; selecting at least one of the cluster contour lines from the ranked cluster contour lines; generating tracks by offsetting each of the smoothed selected at least one cluster contour lines; smoothing the generated tracks to maintain steerability of the farming equipment when operating on the physically tangible agricultural field; returning the smoothed generated tracks as at least a portion of the field data; providing specifications of existing farming equipment; using the provided specifications and the provided field data to determine a first optimized path plan for the existing farming equipment on the physically tangible field; retrieving specifications for at least one piece of other farming equipment from an equipment database; using the retrieved specifications and the field data to determine a second optimized path plan for the at least one piece of other farming equipment on the physically tangible field; calculating at least one of optimized path distance and optimized path travel time for the existing equipment on the first optimized path plan; calculating at least one of optimized path distance and optimized path travel time for the at least one piece of other farming equipment; and reporting results of a comparison between at least one of the optimized path travel time for the existing equipment and the at least one piece of other farming equipment, and the optimized path distance for the existing equipment and the at least one piece of other farming equipment.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1A is a drawing which illustrates some of the numerous equipment attributes that can be added into the equipment database and thus used by the equipment explorer and/or the path planning systems;

FIG. 1B is a drawing of a flow chart which illustrates an algorithm for an equipment selection method and apparatus according to an embodiment of the present invention;

FIGS. 2, 3, and 4 are drawings which illustrate the trampling reduction embodiment of the present invention;

FIGS. 5A and 5B are drawings which illustrate farm selection and equipment data entry fields for an existing equipment configuration;

FIG. 6 is a drawing which illustrates an output showing time and distance details for a farming operation on the selected farm and using the existing equipment to create a baseline for comparison;

FIG. 7 is a drawing which illustrates an output showing time and distance details for the same farming operation on a proposed new equipment setup for comparison against the baseline setup;

FIGS. 8A and 8B are drawings which illustrate the side-by-side comparison of the results of the baseline farming setup vs the proposed new equipment setup for one or more actual fields that the farmer farms;

FIG. 9A shows the input and outputs for dollar savings between the two configurations;

FIG. 9B is a comparison that shows percentage savings of one equipment configuration over another;

FIG. 10 is an algorithm for sorting the longest line segment in an image to find the longest straight line on a field;

FIG. 11 is a drawing which illustrates the top 4 results of the algorithm of FIG. 10 on a field that is mostly rectangular in shape;

FIG. 12 is a drawing which illustrates the top 4 results of the algorithm of FIG. 10 on a field that has an irregular shape with non-farmed areas within it;

FIG. 13 is a drawing which illustrates the top 4 results of the algorithm of FIG. 10 on a field that has an elongated L shape;

FIG. 14 is a drawing which illustrates the top 4 results of the algorithm of FIG. 10 on a field that has a mostly L shape;

FIGS. 15A and 15B are drawings which respectively illustrate cluster-based contours that are identified using the teachings of an embodiment of the present invention for a first geographic location (FIG. 15A), as well as a drawing which illustrates simple single elevation contours of the same geographic location (FIG. 15B);

FIGS. 16A and 16B are drawings which respectively illustrate cluster-based contours that are identified using the teachings of an embodiment of the present invention for a first geographic location (FIG. 16A), as well as a drawing which illustrates simple single elevation contours of the same geographic location (FIG. 16B);

FIGS. 17A and 17B are drawings which respectively illustrate cluster-based contours that are identified using the teachings of an embodiment of the present invention for a first geographic location (FIG. 17A), as well as a drawing which illustrates simple single elevation contours of the same geographic location (FIG. 17B);

FIG. 18A is a drawing which illustrates a diagram of workflow that can be used to perform a method of the present invention;

FIG. 18B is a drawing which illustrates a flowchart for an implementation of cluster-based contour generation for some steps of an embodiment of the present invention;

FIG. 18C is a drawing which illustrates a flowchart for a core cluster-based contour generation algorithm according to an embodiment of the present invention;

FIG. 18D is a flow chart which illustrates workflow for clearing contour lines according to an embodiment of the present invention;

FIG. 18E is a flowchart which illustrates splitting workflow for closed or nearly-closed contour lines;

FIGS. 19A and 19B are drawings which respectively illustrate the results of edge detection for a plot of land without duplication-based upsampling (FIG. 19A) and the results of edge detection for the same plot of land using duplication-based upsampling, Laplacian and threshold (FIG. 19B);

FIG. 20 is a drawing which illustrates an example of cleaned contours, and split contours so as to show intermediate contour and a visualization of cleaning, wherein the lighter lines represent original contours and wherein some of those original contours have been overwritten with a smoothed (cleaned contour) lines and wherein the dots represent splitting candidate points;

FIG. 21 is a drawing which illustrates contour lines split using the above workflow wherein each of the different line types represent a split part of the contour line;

FIGS. 22A and 22B respectively illustrate a 1 m elevation contour map (SECs) for a plot of land (FIG. 22A), and contour extraction results generated using an embodiment of the present invention (FIG. 22B)—note that the dotted line represents the smoothed contour line using a form of polynomial regression;

FIGS. 23A and 23B respectively illustrate a 1 m elevation contour map (SECs) for a plot of land (FIG. 23A) and contour extraction results generated using an embodiment of the present invention (FIG. 23B)—note that the dotted line represents the smoothed contour line using a form of polynomial regression;

FIGS. 24A and 24B respectively illustrate a 1 m elevation contour map (SECs) for a plot of land (FIG. 24A) and contour extraction results generated using an embodiment of the present invention (FIG. 24B)—note that the dotted line represents the smoothed contour line using a form of polynomial regression; and

FIGS. 25A and 25B are drawings which respectively illustrate a 1 m elevation contour map (SECs) for a plot of land (FIG. 25A) and contour extraction results generated using an embodiment of the present invention (FIG. 25B)—note that the dotted line represents the smoothed contour line using a form of polynomial regression.

### DETAILED DESCRIPTION OF THE INVENTION

Embodiments of the present invention relate to a method and software for planning and/or evaluating farming activities which enable the farmer to increase his or her efficiency by reducing time, fuel, and/or mileage on equipment and/or by reducing wasted resources while maximizing production on a particular plot of land.

In order to efficiently plan a farming operation a farmer needs to know not only what crop they intend to plant on what parcel of land but also what equipment they will be using to plant and maintain that crop until it is harvested. However, it is currently extremely difficult or impossible to know or consider all of the aspects of the power unit and the implements (i.e. the equipment), that would affect the overall operation of that system and it is especially challenging for a farmer to consider replacing existing equipment or adding new equipment because every piece of equipment introduces new variables and different specifications, and the effect of adding each implement effects not only the resulting system, but also the power unit itself.

Because the power unit and the implements must function together as a system, changing an implement thus changes the performance of the entire system in numerous ways. Therefore, it is not a simple case of saying, “this sprayer is twice as wide, so now we can apply fertilizer twice as fast”. This is because the wider sprayer will result in a wider turning radius that will take more time and require more turning area and the same power unit may need to travel slower while pulling the larger sprayer. In addition, the original sprayer may have had a wheel spacing and size that enabled it to be pulled with its wheels between crop rows whereas the new sprayer has a wheel spacing or size that will result in the wheel trampling two or more rows of crop as it travels in the same row spacing when it is used. This means that in order to properly plan a farming operation, a farmer needs to know all of the steps he will take and the details of every piece of equipment that will be used during that crop cycle. And, if something is changed after the rows are planted, it may result in wasted crop, resources, and/or productivity.

When purchasing new equipment, the farmer needs to be able to evaluate how it will change his or her entire farming operation and the productivity that can be expected. Thus, embodiments of the present invention enable a farmer to estimate productivity across each of his or her fields with minimal input. This comes not only from planning efficient planting, spraying, and harvesting travel paths for each field, but is also based on the knowledge of every piece of equipment that will be used.

Embodiments of the present invention relate to an automated path planning system. The path planning system is preferably configured such that it can gather data from a comprehensive equipment database. Embodiments of the present invention preferably also use the comprehensive equipment database in conjunction with the path planning system to enable a user to compare the results of changes in equipment (power units, implements and/or other farming equipment). Specifically, such results, can include time performing one or more farming procedures, distance traveled for one or more farming procedures, fuel used for one or more farming procedures, a direction of travel and path plan for one or more fields, and a total time savings and/or total reduction in distance traveled, which can optionally provide a projected total harvest volume for one or more fields. The comparing of results system and method is hereinafter occasionally referred to as “equipment explorer” in that it enables a user to explore different equipment options while accurately predicting the impact of such changes in equipment—not merely on a hypothetical square patch of land, but on a detailed map of the actual field or fields that the farmer will use the system on, which can optionally be obtained, for example, from a satellite image of the actual field.

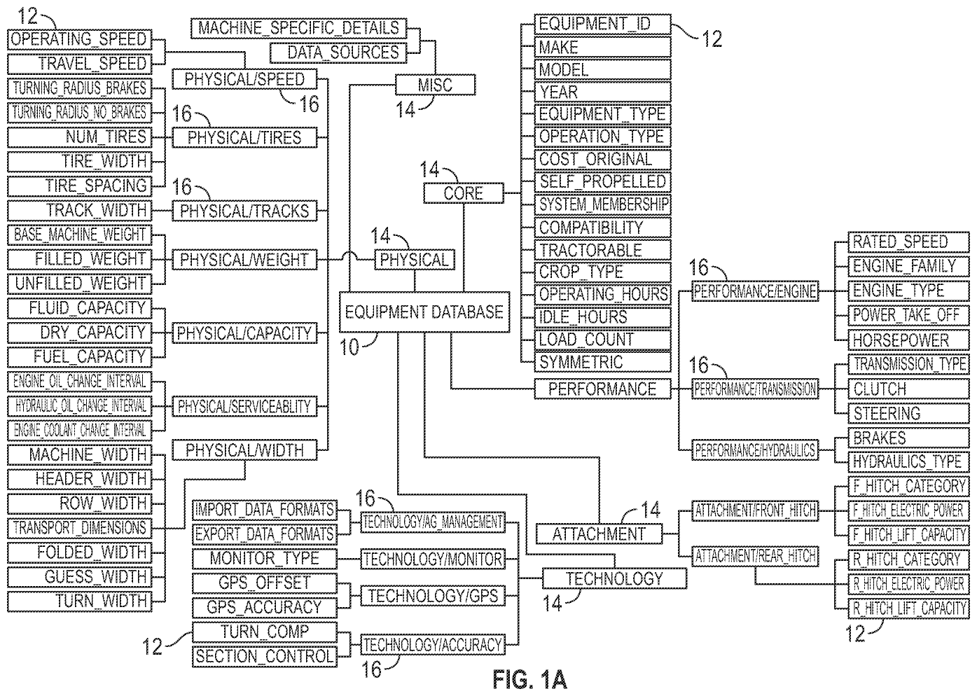

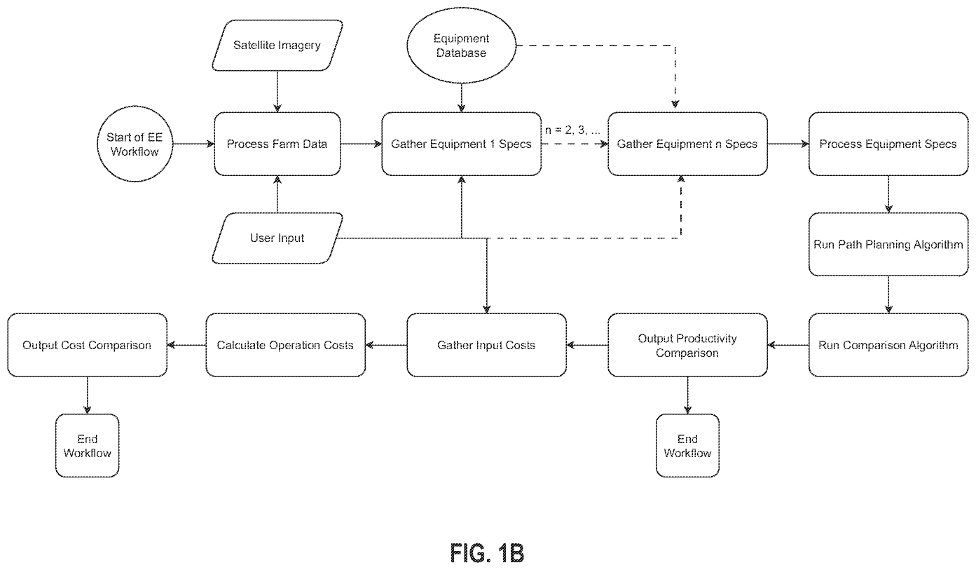

As best illustrated in FIG. 1A, in one embodiment, comprehensive equipment database 10 of farm equipment (particularly broad acre farming) preferably comprises numerous attributes 12 for each piece of equipment contained within database 10. Although FIG. 1A calls out only a few of the attributes with reference number 12, it is to be understood that each of the attributes illustrated therein are referred to herein by reference number 12. Such attributes can optionally include, and are not limited to: maximum speed, effective width (i.e. planting, spraying and/or harvesting) tire width, wheel track spacing, weight, minimum recommended required power; volume and/or weight of product (i.e., seed, fertilizer, or other chemical), turning radius, tongue length, number of planting rows, row spacing, turning speed, working speed, row and/or section control, GPS accuracy, GPS device and/or antenna location on the equipment, and whether an auger or some other component that needs to be routinely accessed is on a left or a right side of the equipment or can be placed on the left or the right side or at some other location. These attributes 12 can optionally be categorized or otherwise grouped by or associated for attribute type 14, which can optionally include things such as physical attributes, attachment type, core attributes, associated technology, and other attribute types. Optionally, the attributes can further be categorized or otherwise grouped by one or more attribute sub-types 16. FIG. 1A illustrates some of the attributes that can be collected in the database and used by the equipment explorer and/or the path planner.

An example of an algorithm preferably used by the method and apparatus of the equipment explorer is illustrated in FIG. 1B. As can be seen therein, upon starting the method, satellite imagery of one or more fields and user inputs is preferably obtained and processed as farm data. Equipment specifications, which can come from selections of equipment contained in the equipment database and/or from data input from a user, are preferably gathered from any desired number of equipment configurations/selections. The equipment specifications are then processed, and a path planning algorithm is performed with respect to each equipment configuration to be compared, such that an optimized path plan on the actual field is obtained for each equipment configuration. The resulting path plans and equipment configurations are then compared, and the productivity comparison is then output. Input costs are provided, this can come from user inputs and/or from any other desired source of costs. Operation costs are then calculated and output to the user such that the user can review the resulting operating costs and productivity comparisons. This algorithm is preferably implemented in computer software.

Equipment explorer preferably can calculate the possible speed ranges for a selected power unit and implement combination, including estimated working speed and turning speed based on implement width (swath width) and machine type.

Embodiments of the present invention also provide the ability to reduce and/or minimize trampling of existing crops during spraying or other crop maintenance operations. There is a problem in the solid seeded crop market today where sprayers trample crop and negatively impact crop production both by reducing yield and wasting inputs. There is also a problem in row crop as well—examples are fatter tires for wet conditions or running across the rows with narrower row spacing such as 15-22″.

Due to seed row spacing of 7″-12″ (10″ most common), sprayer tires do not fit between the rows. Most sprayer tires range from 15″-24″ which means at least 1 and up to 3 rows of crop are trampled from each sprayer pass track—when spraying parallel to rows. For a large farming operation, this can result in 100s of acres trampled with significant impacts to yield, quality, and income. Further to the problem, trampled acres are treated similarly to all acres in a field. Seed is placed in the soil along with crop protection and fertilizer at a significant cost, in many cases exceeding $200 per acre, only to be damaged to the point where there is a net loss across all trampled areas of a field by sprayer tracks.

The uniqueness of the solution lies in leveraging existing original equipment manufacturer (“OEM”) technology in combination with the path planning algorithms to prescribe the movement of machinery in a field that synchronizes the paths of seeding and spraying operations so that a seeding operation can predetermine the tracks of a sprayer and automate the row controls of seeding equipment to cease delivery of seed and fertilizer to the direct areas of a field that will ultimately become trampled.

For example, a farmer operating with a 76 ft seeder and 120 ft sprayer would be extremely challenged to implement an efficient sprayer path due to the misalignment of implement width. Farmers purchase wider sprayers to reap the benefits of more acres per hour, less compaction, tracks, and trampling. By aligning implement widths that do not match (in terms of ratio) to try to reduce compaction would result in unnecessary overlap, compaction and time—thus removing the benefit of a wider sprayer in the first place.

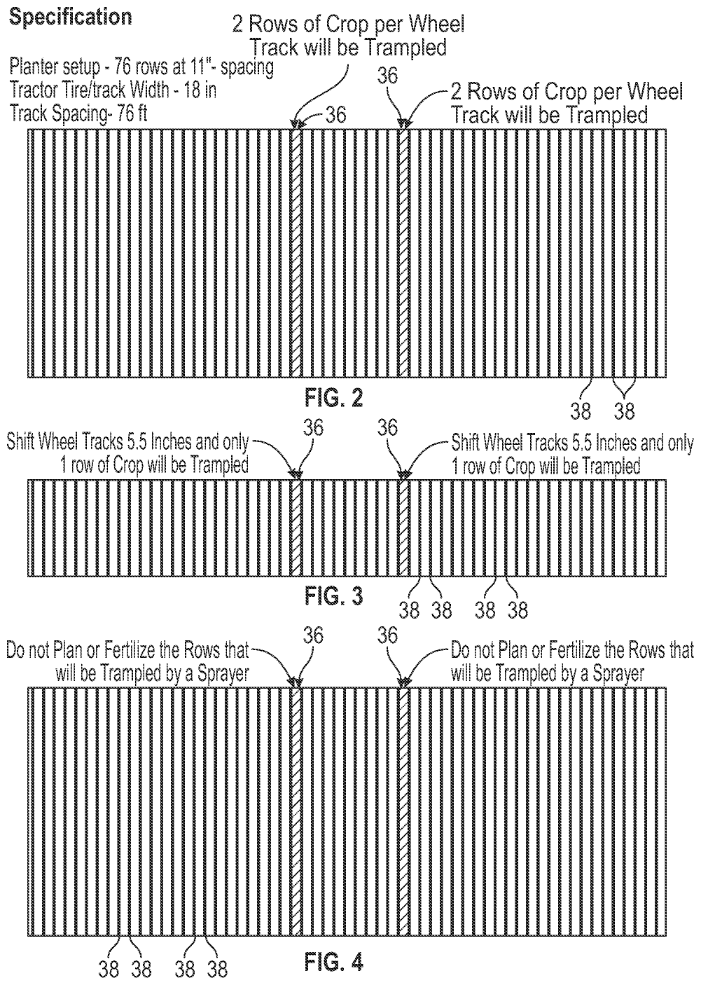

Referring now to FIGS. 2-4, the trampled area is the amount of area of trampling happening in a field (this requires a link between seeding and application (another operation other than harvest). To determine the trampling impact with respect to heading, alignment is made parallel to row headings so that a seed row 38 is the center line for a sprayer tire resulting in 1 row trampled per tire as opposed to 2 or more. A prescribed tramline is preferably generated whereby a seeder/planter is made to create tram lines and determine the value to the grower based on cost savings from inputs and yield increase due to reduced trampling by wheel tracks 36. This can include greenhouse gas (“GHG”) savings, which can include the reduced carbon applied due to the reduced fertilizer that needs to be sprayed. When traveling parallel to a seeded row 38, a user can align sprayer tracks to reduce trampling by only trampling 1 or 2, but not 3 rows 38. This can be executed in the field using a real-time kinematic (“RTK”) system.

By accessing or importing the various parameters of the equipment, including for example, wheel spacing and tire width, embodiments of the present invention enable a user to align the application operation to the seeding operation and fine tune exactly which rows will be trampled in the farmer's field before the new equipment is even purchased and before the first seed is planted.

Embodiments of the present invention thus minimize the economic impacts of in-crop application trampling via a method and software which enables farmers to prescribe a tramline and thus achieve fertilizer and seed reductions without having to change product placement, rate and timing. The result is a direct reduction of inputs applied to the land.

In one embodiment, the present invention can determine the trampling impact with respect to a heading—for example by considering trampling whole rows while operating parallel to the rows versus going across the rows at some angle. Then, based on a crop value and the yield potential in the trampled area, the present invention preferably calculates and outputs the total yield and monetary loss for their trampled area. Further, by prescribing a seeder/planter configuration to create tram lines, the trampled crop area can be re-calculated using the prescribed tramlines to calculate the total yield and/or monetary loss for the trampled area of the updated farming configuration. Then, the total yield and/or monetary loss of the first configuration can be compared with the total yield and/or monetary loss of the second configuration to provide the value to the grower based on cost savings from inputs and yield increase due to reduced trampling.

Thus, in one embodiment, the present invention can reduce trampling on existing farms while using existing equipment, thus resulting in cost savings and increased profits with nothing more than implementing a different planting and/or spraying configuration.

In this embodiment, the wheel spacing, tire width and alignment of each tire are preferably modeled or otherwise recorded and then applied to a path plan for a farmer's field in order to create an application plan and use the wheel tracks to create a seeding plan where particular rows are not seeded (i.e. where tires will be traveling in future farming operations). Thus, in the method and software, wheel tracks are used as passable internal obstacles that the seeder will not plant at, but which can be driven through with the framing equipment.

FIGS. 2-4 illustrate the concept of determining and providing a prescribed tramline. In this example, we are picking up an opener and creating a tram line by creating an application plan and then using the wheel tracks to create a seeding plan where particular rows 38 are not seeded. Using the wheel tracks to use as passable internal obstacles that the seeder uses to determine where not to plant.

In one embodiment, the path planning provides the ability to use equipment attributes to determine planned coverage which is a model of the coverage of equipment based on the field boundary, equipment dimensions and technology to map and visualize where the machine and equipment are going to cross over before it happens and then calculate the amount of area and volume of seed, crop protection, and/or fertilizer and distance traveled, fuel used and time in order to calculate estimated costs and to then calculate estimated savings based on compared, proposed, new or different equipment.

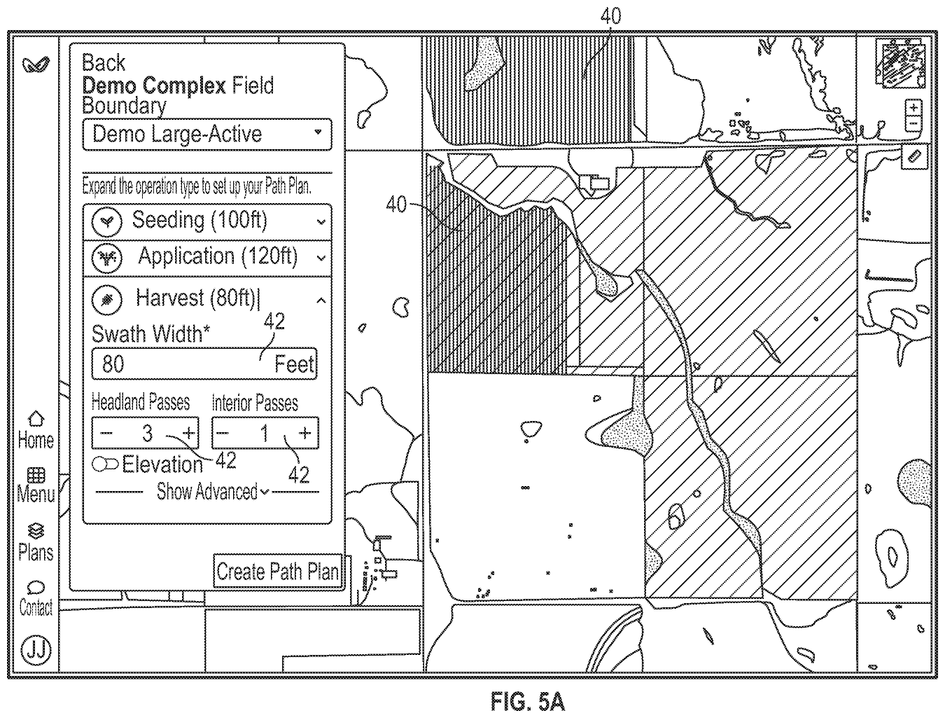

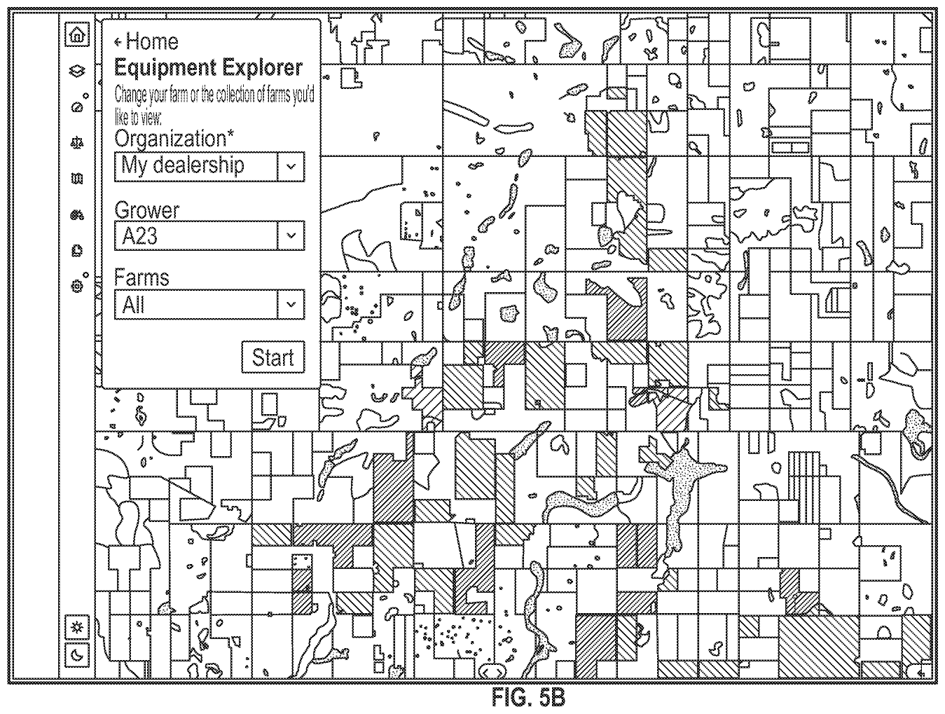

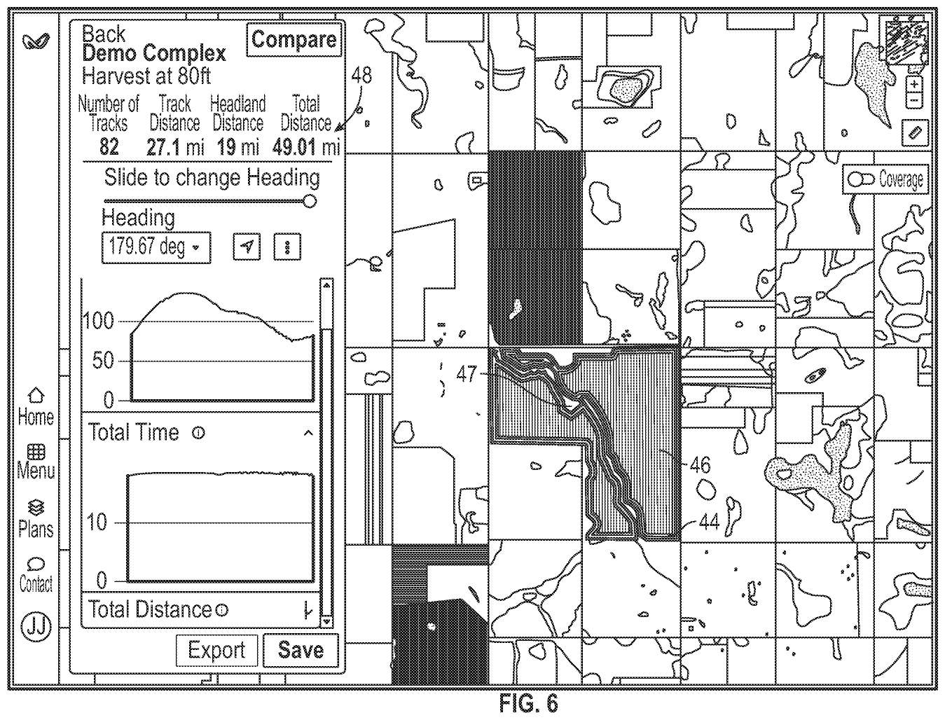

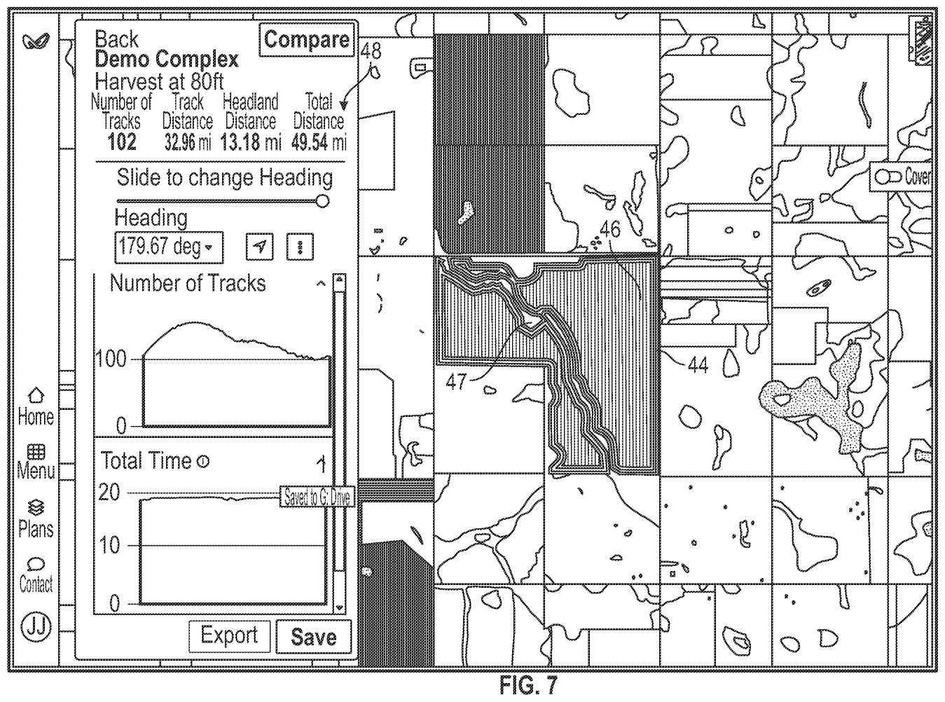

As best illustrated in FIGS. 5A and 5B, a user can select any one or more of their actual fields 40 from a map, which can optionally come from a satellite image database or other map database. Preferably, the image of the user's field is display on the user interface. The user can then input any of various attributes 42 about their existing equipment and/or farming technique to calculate a baseline of the time, distance, and speed to farm the one or more fields, as well as a diagram which illustrates the path that the existing equipment setup will take as it passes over the field. For example, as illustrated in the image of the field on FIG. 6, the number of headland passes 44 can be displayed as well as the paths 46, which in the example of FIG. 6 are passes arranged in northerly and southerly directions. Details 48 about one or more farming operations can be displayed to the user. For example, in the example of FIG. 6, for a harvesting operation on that field with that unfarmable creek feature 47 running through it, the number of tracks the harvester must make are 82 with a total track distance of 27.1, a headland distance of 19 and a total distance of 49.01 and the heading to start out would be 179.67 (i.e. southerly). These outputs can then be stored, and a set of new attributes can be entered regarding a different setup configuration—for example a possible new setup configuration that the farmer is considering purchasing can be entered and ran on the same field(s) to produce a set of output data for the second equipment configuration (see FIG. 7). The user can then run a comparison of the existing setup to the proposed setup to display results 50 of the two operations and/or to illustrate any savings—for example time savings, monetary savings, distance driven savings, etc.

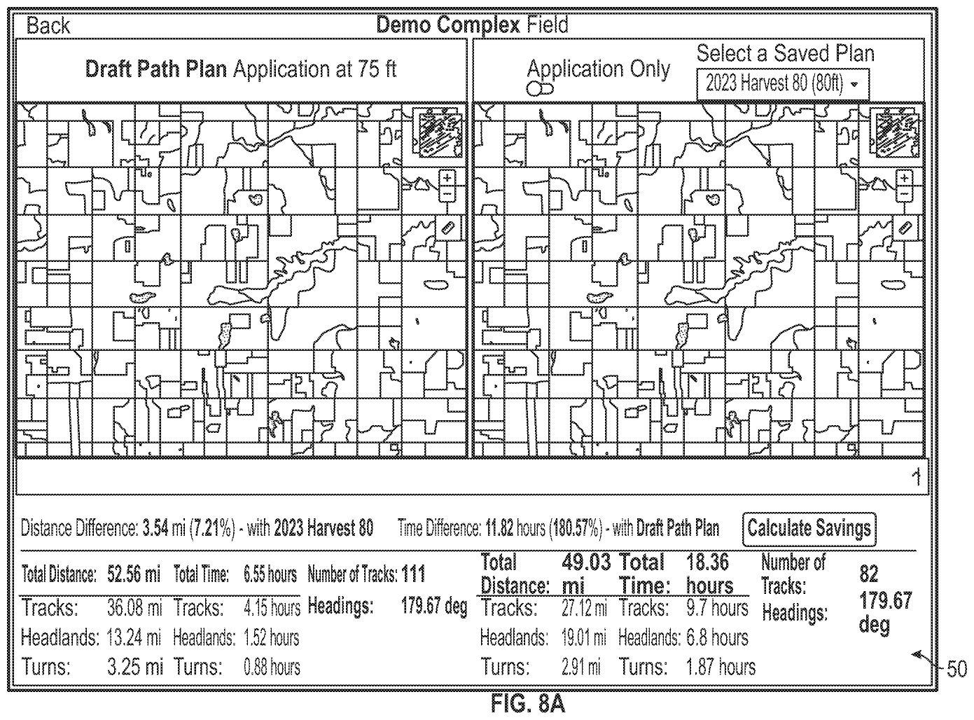

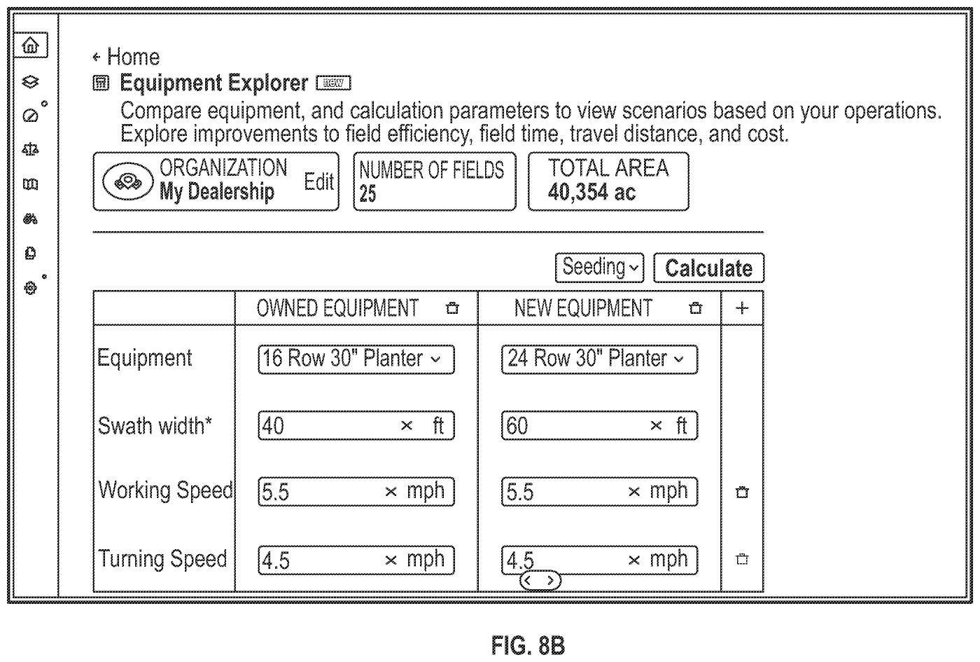

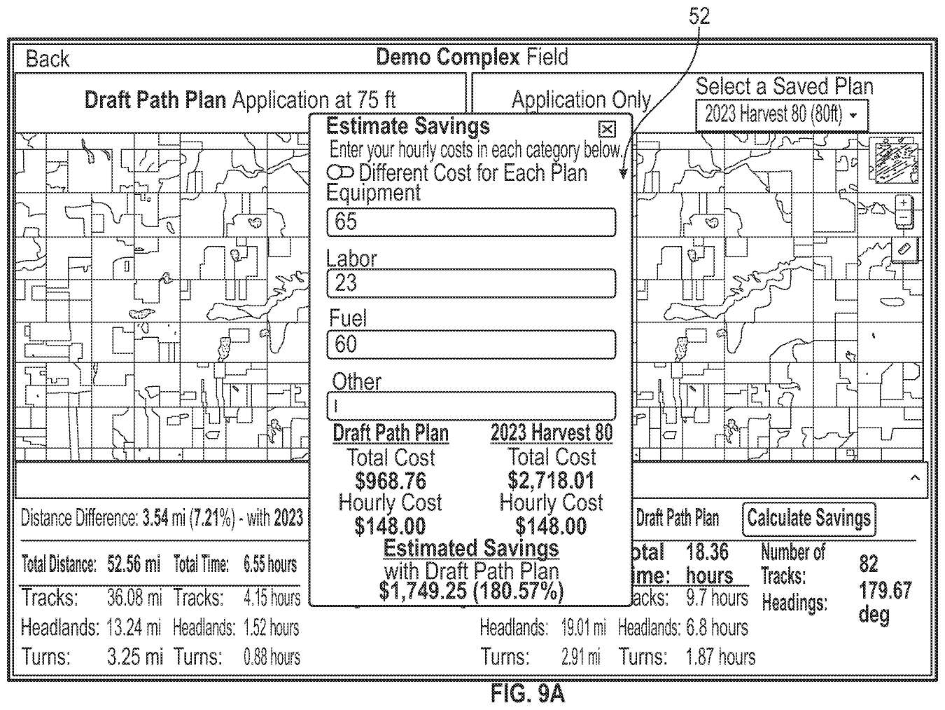

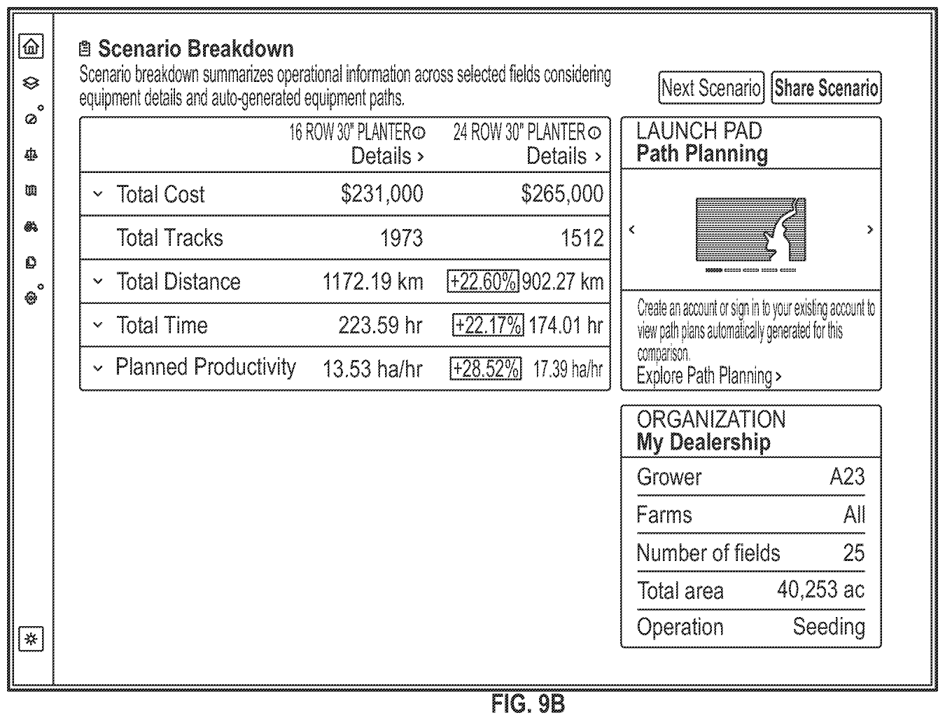

As illustrated in FIG. 8A, for example, the 75 piece of equipment that is being compared to an 80 foot piece of equipment results in a distance savings of 3.54 miles, which is 7.21%) and the total time savings of 11.82 hours with the new path plan that can be achieved using the 80 piece of equipment. FIG. 8B illustrates a user interface where a user is able to enter and/or select equipment to compare—for example an existing 16 row planter vs a 24 row planter. Finally, the user can input cost values 52 for various aspects of the farming operation—for example hourly equipment cost, hourly labor cost, hourly fuel cost, etc. As illustrated in the examples of FIGS. 9A and 9B, the method and computer software can then calculate and illustrate the costs for the existing system (“2023 Harvest 80” in FIG. A) and the proposed new setup (“Draft Path Plan in FIG. 9”). In one embodiment, the proposed new setup and/or the existing setup can be selected from a database of equipment such that a user need not enter data regarding aspects of the equipment and/or a user need only enter some data for equipment while data for other aspects is pulled from the database.

### Longest Straight Edge

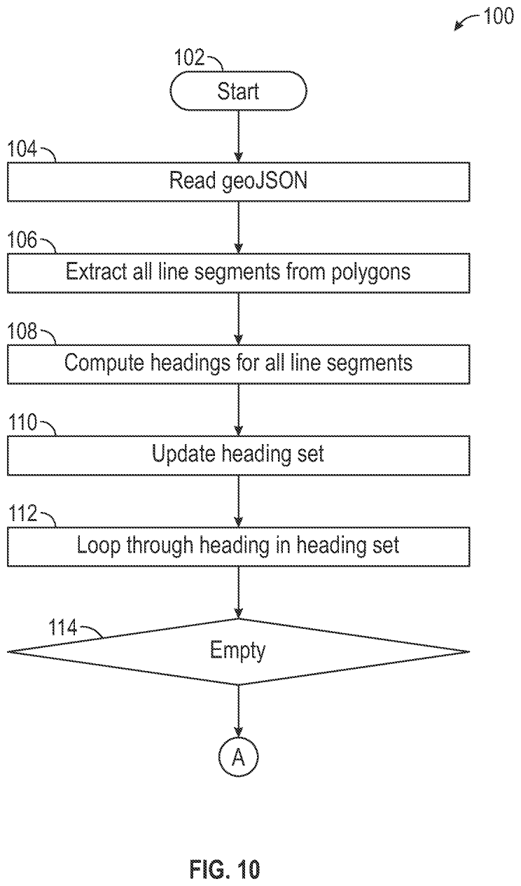

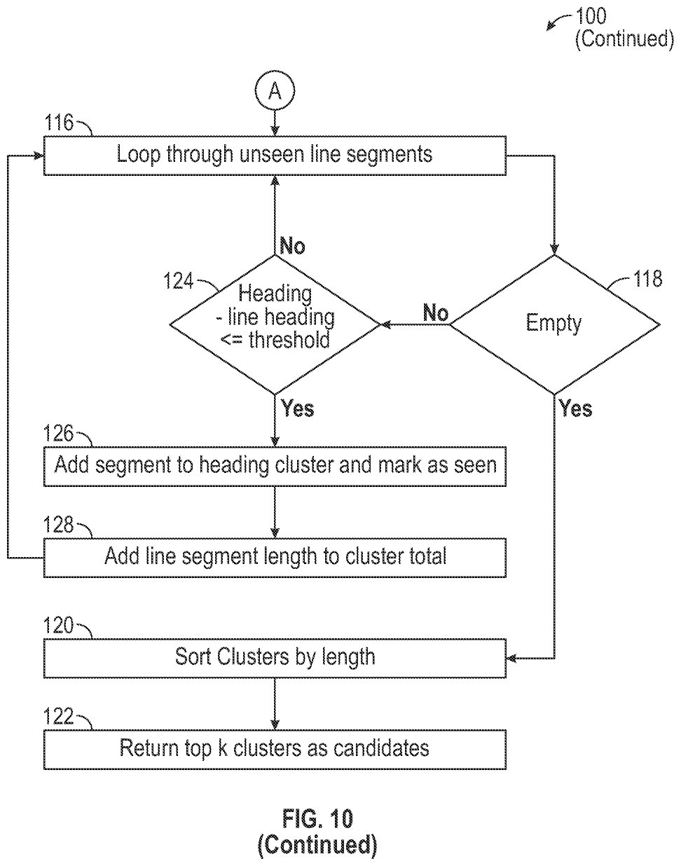

An embodiment of the present invention also preferably finds the longest straight edge in a field or the boundary of a field, thus enabling a farming path to be planned such that it is aligned parallel with that longest straight edge of a field boundary. As best illustrated in FIG. 10, the algorithm preferably clusters line segments from a field's boundaries into buckets of similar bearings. The buckets are ranked by total length of the line segments within the top-k requested edges and are presented to the user as output. In the algorithm of FIG. 10, at start 102, a geoJSON file is preferable read or otherwise obtained 104 from which all line segments are extracted 106 from polygons. Although FIG. 10 specifically illustrates the use of a geoJSON file type, that illustration is intended to represent any other desired input and/or output file type that can be used for data storage for geographic locations and/or features, including but not limited to a shapefile or other standard input/output file types. Throughout this application, when the term “geoJSON” is used it is intended to also include any of these other file types. Headings are computed 108—preferably for all line segments, before a heading set is updated 110. Then a loop 112 is preferably performed through each heading in the heading set until reaching the end 112 of the heading set. Then, each unseen line segment is preferably looped through 116 until reaching the end 118, at which point the clusters are sorted 120 by length and the topo clusters are returned 122. While looping through unseen line segments, if the end of the line segments has not been reached 124, then the segment is added 126 to the heading cluster and the line segment is added 128 to the cluster total.

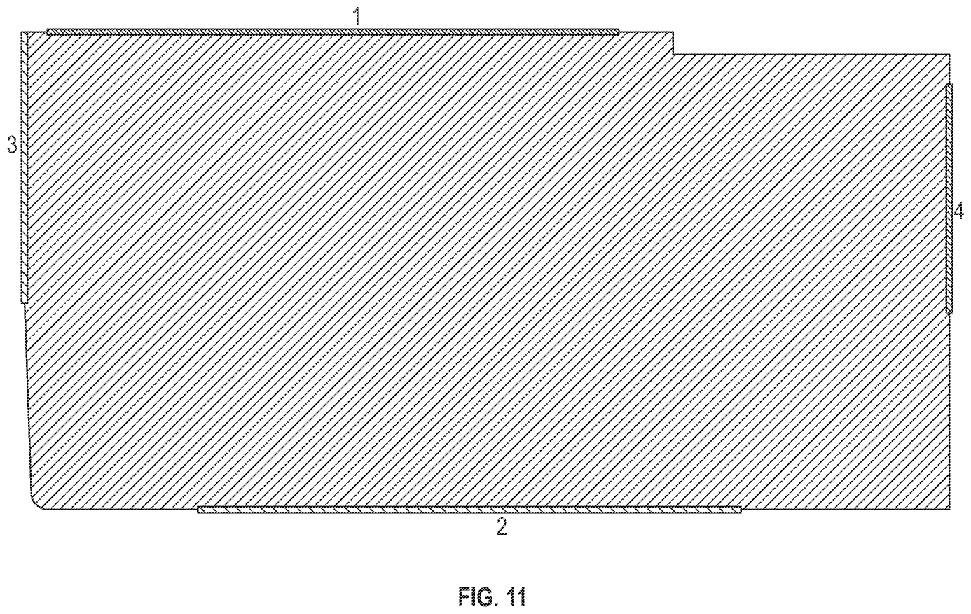

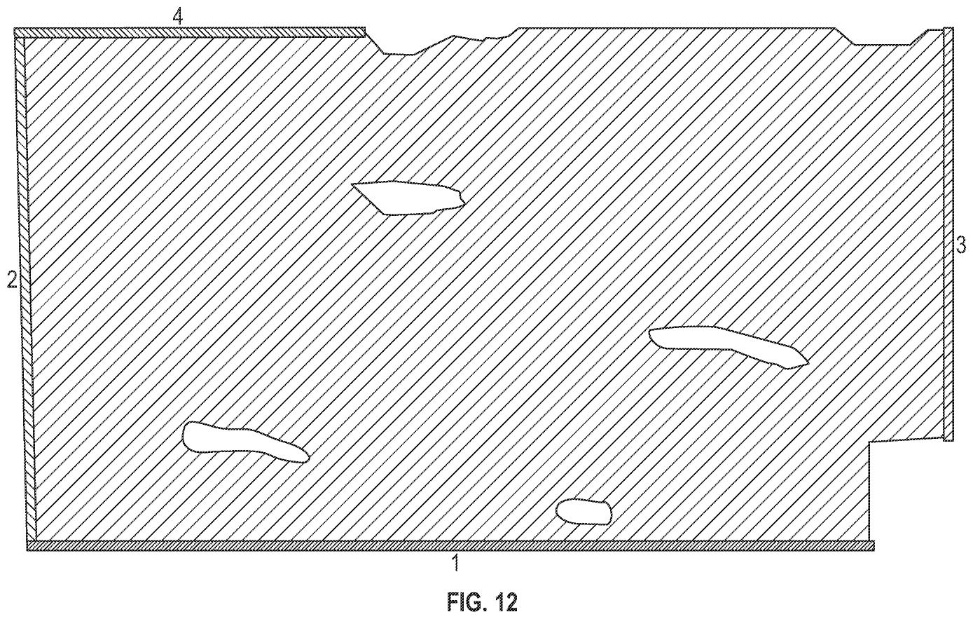

FIGS. 11-14 are examples of polygons that represent fields, which have had the algorithm of FIG. 10 applied to them such that the 4 longest straight edges are identified and presented to the user (the numbers represent the ranking, thus “1” represents the longest straight edge). Because of natural geographic formations and features, fields are seldom perfectly square or rectangular in shape, the algorithm is preferably performed via computer software because attempting to perform the calculation in the mind of a user would be exceedingly difficult or impossible.

As can be seen in the figures, the numbered line segments do not appear to extend the entirety of the straight side. Although the straight edges should extend all the way in a perfectly rectangular or polygonal field, sides of real-world fields (such as those illustrated) are never perfectly straight. The algorithm preferably finds the line of best fit through as many of the points as possible on a side of the field while keeping the angle variation between points within a predetermined angle tolerance. By increasing the angle tolerance, a user can lengthen the straight edge. However, this lengthening results in greater overlap at the edge due to imperfect alignment. In one embodiment, the algorithm preferably performs a trade-off between length and alignment. In FIGS. 11-14, if the fields that are illustrated had sides are perfectly straight, the straight edges would be lengthened such that they are the entirety of the respective side. If a side is straight except for a small bumped-out portion, in one embodiment, the can continue across that feature, so long as the side portions on each side of the bumped out feature are aligned with one another (or are within the angle tolerance).

In one embodiment, the algorithm is preferably able to return the following information in a data structure:
1) the longest line within a cluster of lines with similar bearing (overlaid on the fields below);
2) the bearing of the line described in item 1 above;
3) the sum of line segment lengths in a cluster; and
4) the average bearing of the cluster (sum of all bearings/number of line segments).

Once the longest straight edge, or the top choices for the longest straight edge are obtained, the user preferably reviews them and makes a decision to farm parallel to one longest or one of the longest straight edges. For example, one reason that a user may choose to farm parallel to the second longest straight edge instead of the longest straight edge may be because farming in that direction would result in a farming pattern that causes them to make trips such that they are often making a turn near a road, which would enable them to have access to support vehicles, supplies, or equipment from that road.

For straight edge detection, field boundary is preferably represented as a multi polygon, a standard GIS data structure that records the outer boundary and the boundaries of the obstacles in the field as polygons. Each polygon preferably consists of vertices and line segments joining pairs of vertices. An edge of the polygon is a collection of adjacent (joined) and parallel (same inclination/heading) segments.

An edge or a straight edge is preferably a collection of boundary segments having: (i) inclinations within an angle threshold, and (ii) pairwise perpendicular distances within a distance threshold. Thus, an edge can comprise disjoint segments. In one embodiment, the disjointed segments must have their mutual perpendicular distances within the distance threshold or non-parallel segments as long as their inclinations fall within the angle threshold.

The core inputs to the algorithm preferably include the number of target straight edges k, angle threshold a, distance threshold d, and the simplified field boundary B. Simplification is preferably performed by removing noise and vertices that are too close to each other to provide meaningful information about boundary geometry.

All the segments on the boundary polygons are preferably extracted (most preferably in a list data structure) along with their inclinations and lengths. The inclinations are preferably also recorded in a list of inclinations and/or headings. The segments on the boundary polygons are clustered based on the angle threshold and the distance threshold. Clusters are grown as follows: (i) loop through the list of headings, (ii) loop through the segments, and (iii) if a segment's inclination falls within the angle threshold of the heading, add it to the cluster corresponding to the heading.

Clusters are preferably sliced into smaller clusters based on the distance threshold. Thus, for example, segments with the same heading and/or inclination that fall on opposite sides of a polygon or on different polygons will end up in different clusters. In one embodiment, the length of a cluster can be defined as the sum of lengths of the segments in the cluster. The longest k clusters are selected and ordered (descending) by total length.

Clusters are preferably stored in a hash table like data structure to make them deterministic. This results in computational efficiency and removes dependence on the list order. This also ensures that the same clusters are grown irrespective of the order in which the boundary polygons or their segments are traversed.

For each of the k longest clusters, a regression line or line of best-fit is preferably computed by methods standard in the industry. The heading and/or inclination of the line of best fit is also preferably computed, and the information is added to the clusters hash table. The clusters are then preferably returned as output along with the respective lines of best-fit and headings.

In one embodiment, a path plan preferably includes: (i) tracks, which is a multi-line string that includes parallel line strings (a GIS data structure having points and line segments joining them), and (ii) track polygons (i.e. a multi polygon). Each polygon in the path plan preferably represents the rectangular path of the agricultural machine and each line string preferably represents the path of the center of the machine.

The k longest clusters are preferably looped over and returned. The line of best-fit and its heading is preferably used to generate a path plan for the agricultural machine. Several additional inputs are preferably input for generating path plans. In one embodiment, these can include one or more of: track width of the agricultural machine and number of perimeter passes inside the exterior boundary of the field and around the interior obstacle boundaries.

The boundary polygons are buffered inward (exterior polygon) or outwards (interior obstacle polygons), based on the number of perimeter passes requested. The perimeter passes are also preferably computed as a multi-line string representing the path of the center of the machine and associated multi polygon representing the path of the machine as a whole. A bounding box is preferably drawn around the field boundary.

Parallel line strings are generated in the heading of the line of best-fit and pairwise separated by perpendicular distance equal to the track width to cover the bounding box of the boundary. Line strings are translated so they align with the line of best fit. This means that the line of best-fit has a perpendicular distance equal to the track width with its neighboring line strings. Line strings are then clipped to the field boundary. More particularly, parts of a line string falling outside the exterior polygon or inside an obstacle polygon are removed. Line strings are preferably extended so that the corresponding track polygons provide full coverage of the field area. The line strings now represent tracks. Track polygons are preferably computed by methods that are standard in the industry. The tracks and track polygons represent the path plan.

Optionally, other path planning computations (coverage, overlap, distances, times, etc), saving, rendering and exporting steps can also optionally be performed if desired for a given application.

### Cluster Contours.

Embodiments of the present invention also relate to a method and apparatus for extracting a new type of contour lines (referred to herein as “cluster contours” and/or “cluster contour lines” and/or “elevation boundaries”) from terrain information, and/or for using such extracted cluster contour lines as reference or seed lines to generate steerable curved tracks for machines, such that a field can be divided such that sections of the field with similar elevations are grouped to avoid repeatedly farming back and forth across significantly varying elevations. The tracks can be generated by offsetting the reference line in both directions until the entire geographic location is covered. Optionally, the generated tracks can be used as input for the path in the equipment explorer embodiment of the invention. The cluster contours are lines that form a boundary between different clusters of elevation topography, such that topography which falls on one side of a cluster contour line has similar elevation throughout that cluster and such that topography which falls on the other side of a cluster contour line has similar elevation throughout that cluster. By dividing a field with a cluster contour line (or a plurality of such lines) and then performing a farming operation on a first cluster on one side of a cluster contour line before then moving over to the other side of the cluster contour line only once and then performing the farming operation on that second cluster, the total elevation deviation experienced by the farming equipment during the entirety of the farming operation can be reduced, thus improving efficiency of each farming operation while also reducing time and/or expense—including for example fuel.

Some of the advantages of using cluster contour lines vs single-elevation contours include:

1) Using a single-elevation contour as a reference line for a path plan does not prevent the tracks from going uphill and downhill at steep slopes. Contrary to such an undesirable result, if a cluster contour is used according to an embodiment of the present invention, the regions (also referred to herein as “clusters” and/or “elevation regions”) on either side have more gradual elevation changes.

2) Conventional single-elevation contours are arbitrary lines. Using contours at 0 m, 10 m and 20 m leads to completely different results than using contours of other quantities (for example at 5 m, 15 m and 25 m). Contrary to this, cluster contour lines are boundary lines between regions of different elevations in a field.

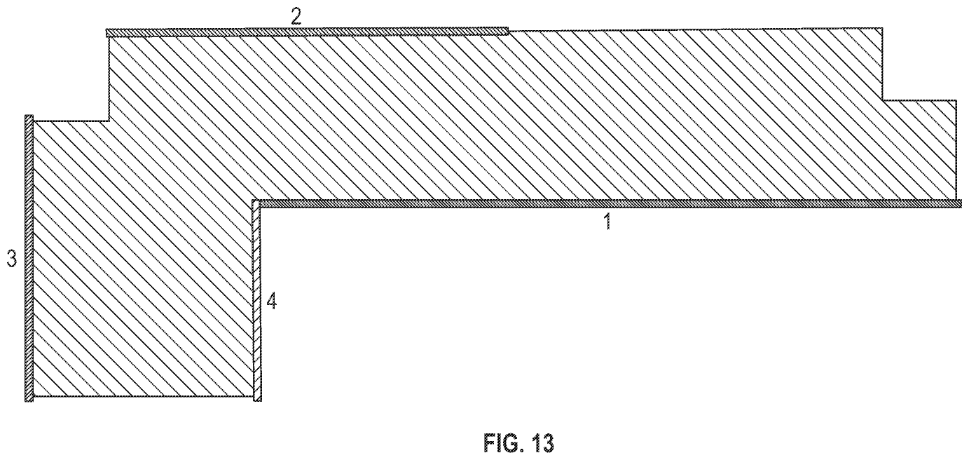

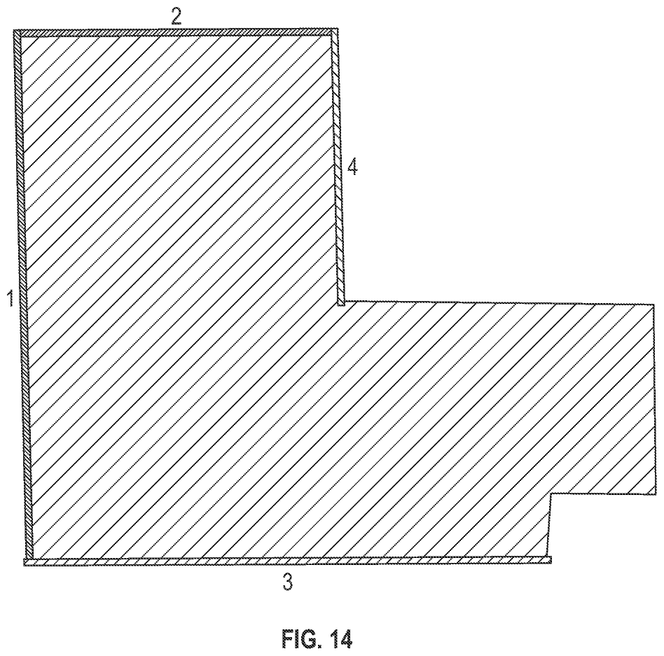

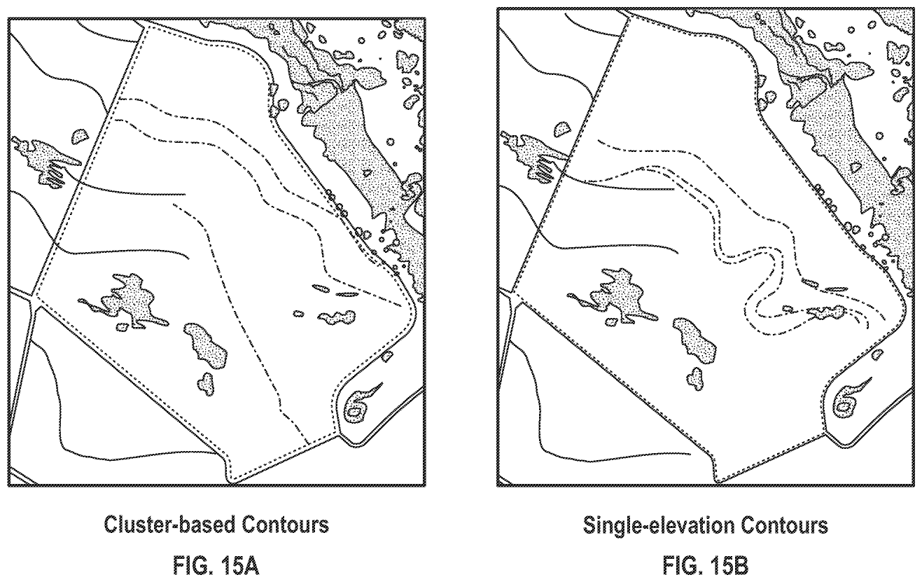

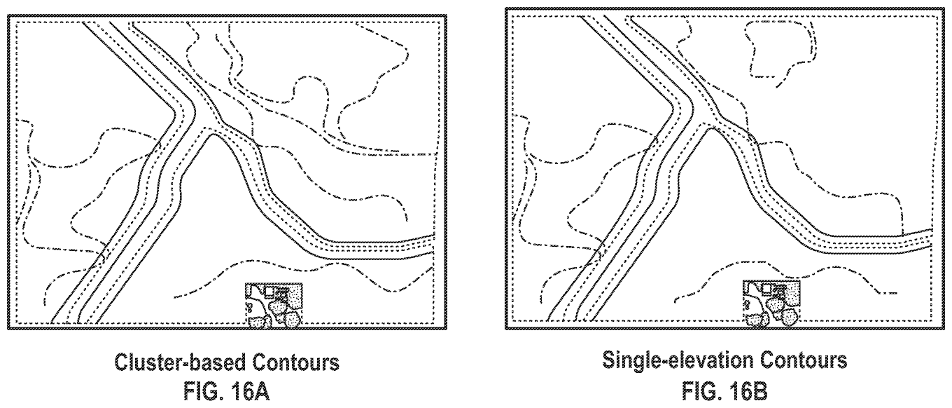

3) Cluster contours are natural partition lines in the field while conventional single-elevation contours are not. FIG. 15A illustrates an example of the results obtained from using cluster contours for a particular plot of land and FIG. 15B illustrates the results of using single elevation contours for that same example plot of land. Likewise, FIGS. 16A and B, and 17A and B, illustrate a comparison of cluster contours vs single elevation contours for a few other plots of land.

Embodiments of the present invention relate to a method that obtains and then preferably performs a machine vision algorithm to the raster data to cluster it into different elevation regions (different “clusters”), extract boundary lines (which are cluster contour lines, that separate these different clusters, ranks the cluster contour lines using criteria, selects the top-ranking cluster contour lines, smooths them to different degrees to improve steerability, offsets the smoothed line to generate tracks, smooths the tracks to maintain steerability, and performs slope-distance analysis on the generated tracks to estimate anticipated soil erosion, distance traveled and other metrics. The top-ranking cluster contours can also be used to partition the field automatically and each subfield path can be planned as above.

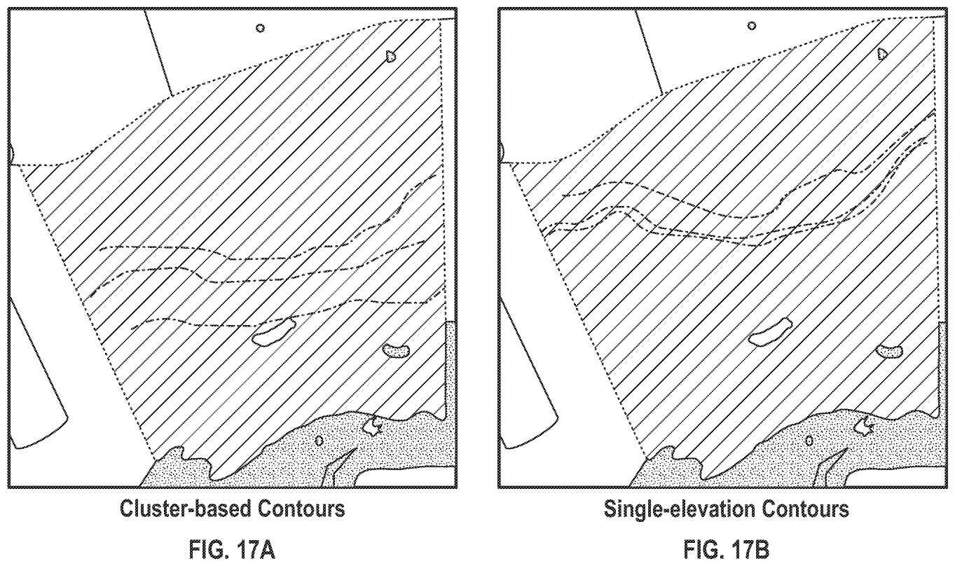

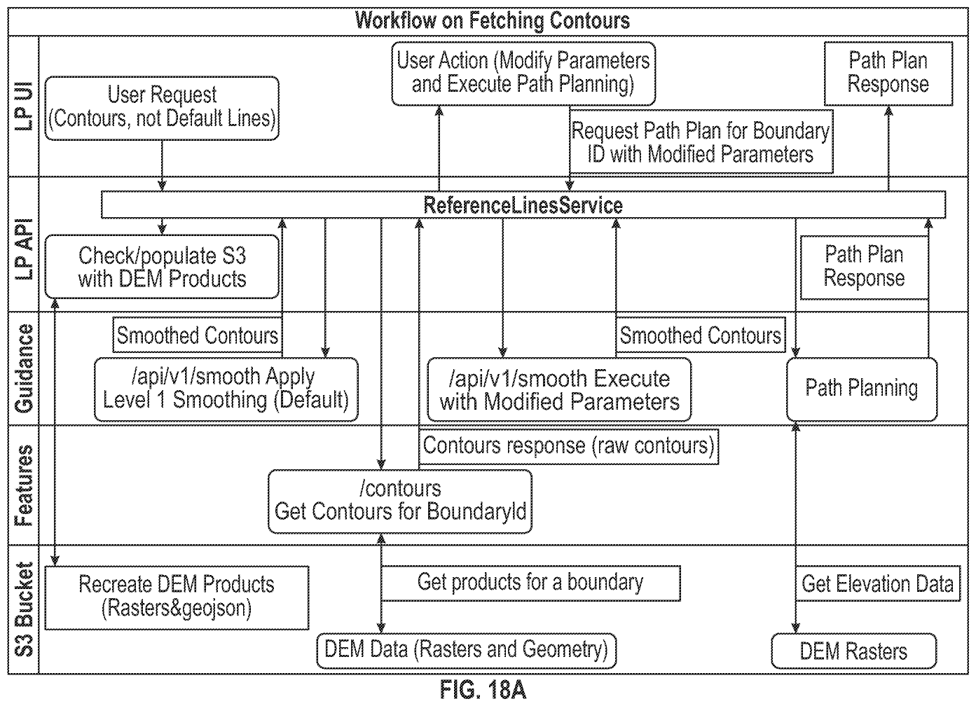

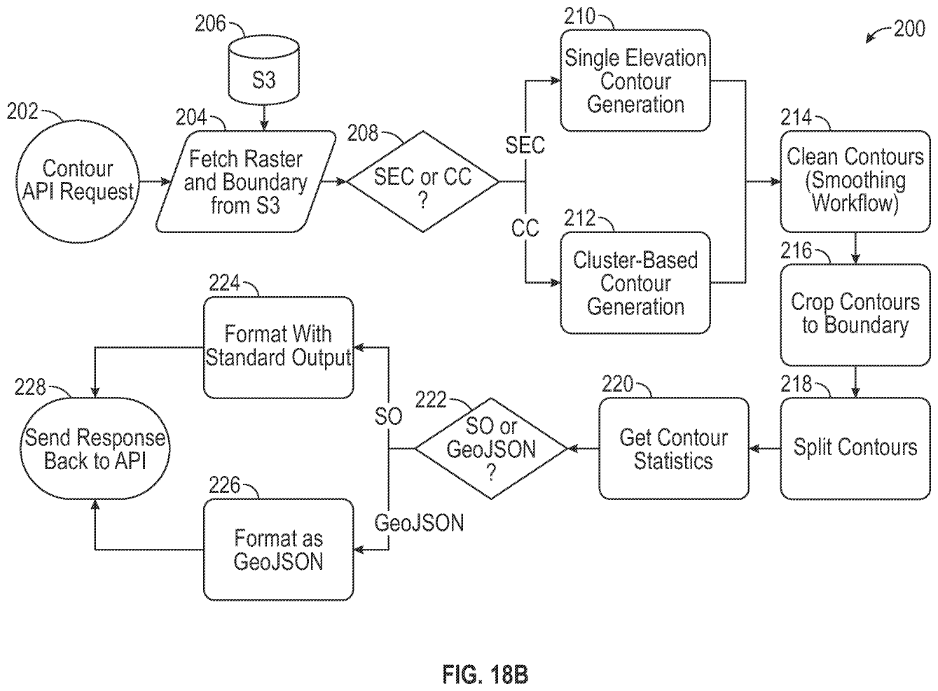

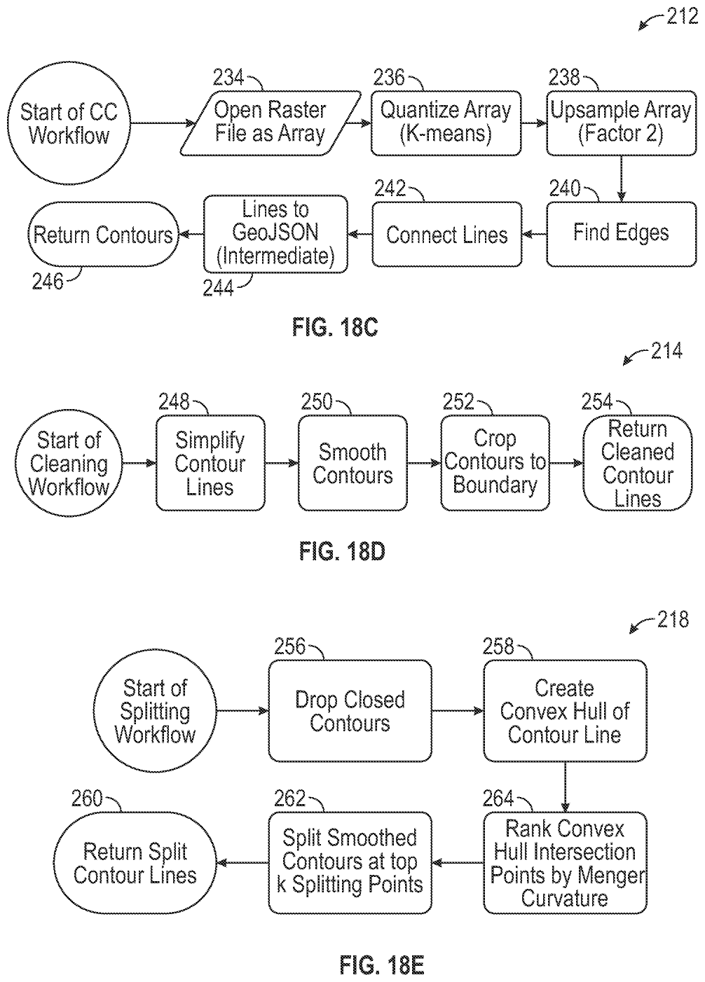

FIG. 18A illustrates a workflow diagram which can be used to produce the cluster contour lines. As best illustrated in FIG. 18B, in one embodiment, the cluster contour method and system 200 preferably begins with a user or application requesting a cluster contour function 202 before the raster and boundary is fetched 204 from data storage 206, which can include for example a simple storage service “S3”. Then, depending on whether method/system 200 is to return a single elevation contour (“SEC”) or a cluster contour (“CC”) 208, either an SEC generation function is called or otherwise initiated 210, or a cluster-based contour is generated 212 (see FIG. 18C for more detail). The contour(s) are then smoothed 214 (see FIG. 18D for more detail) and are then cropped 216 along the boundary of the field or other desired boundary. The contours are then split 218 (see FIG. 18E for more detail) and contour statistics are generated 220. A geoJSON or standard output is then generated. For example, for a standard output, the data is formatted accordingly 224. Likewise, for a geoJSON file, the data is formatted accordingly 226. Finally, the completed response is returned to application 228.

Embodiments of the present invention also preferably:

1. Use a source of raster data (for example the National Aeronautics and Space Administration's Digital Elevation Model (“NASADEM”) to obtain a low resolution (for example about 30 m×about 30 m) raster of a bounding box of the field. A raster is a regular point grid in a region recording the x, y, z coordinates of each point (see FIG. 18B for this step 1 and the following step 2).

2. Upsample the raster, most preferably by using interpolation techniques that can include for example cubic spline interpolation. This increases the resolution to about 5 m×about 5 m or better.

3. Represent the raster data as a tiff file. Other image formats can be used but tiff is a preferred choice.

4 Elevation data is preferably separated into k clusters (regions) using k-means and using k-means clustering with a value of k selected by minimizing a scaled and penalized inertia value.

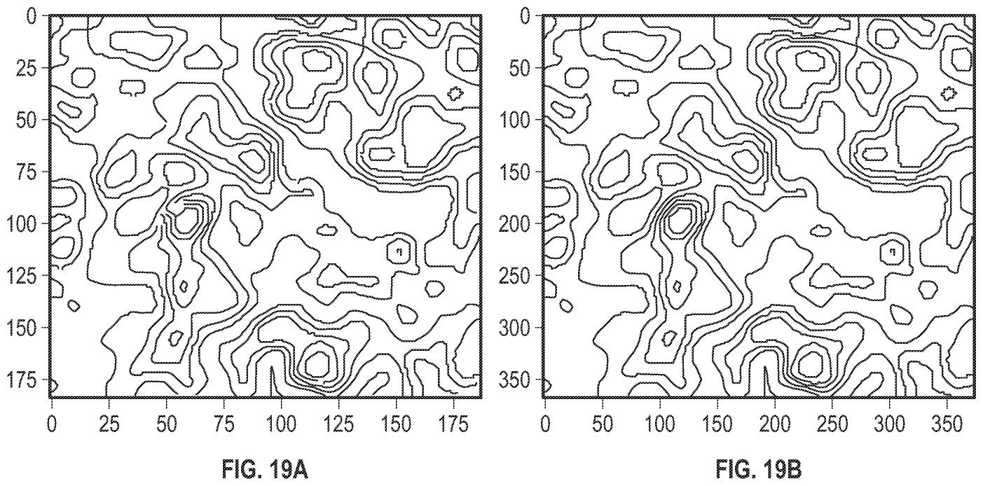

5. Detect and extract lines (which are the cluster contour lines) that separate different clusters using machine vision algorithms that can include for example Canny edge detection (see FIGS. 19A and 19B, which show Edge detection without duplication-based upsampling (19A) and using duplication-based upsampling, Laplacian+threshold (19B)). In one embodiment, the edge detection algorithm preferably further upsamples the raster data by duplicating pixels and applying a Laplacian filter followed by a value threshold (see FIG. 18C for this step 4 and for step 5). As illustrated in FIG. 18C, cluster-based contour generation algorithm 212 preferably opens a raster file as an array 234 which is then quantized 236 (preferably using K-means clustering), the array is preferably then upsampled 238 before machine vision or another algorithm is used to find edges 240, the lines are then connected 242. The lines can then be put into a geoJSON file 244 before the cluster contour lines are returned 246.

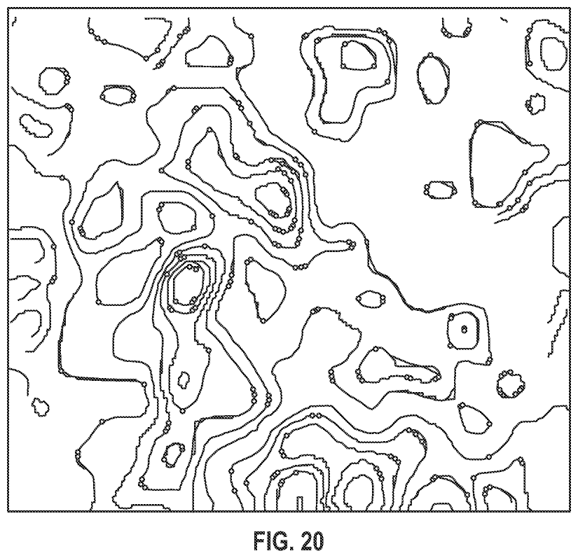

6. Clean the cluster contour lines as needed and remove zigzag or chain like structures from the lines. The geometry of these cluster contour lines is preferably first simplified using a topology-preserving version of Douglas-Peucker simplification. Cluster contour lines are preferably then smoothed using Taubin non-shrinking polyline smoothing. This produces smoothed cluster contour lines. FIG. 20 illustrates an example of cleaned cluster contour lines, wherein some original cluster contours have been overwritten with a smoothed (i.e. “cleaned” cluster contour lines and wherein the dots represent splitting candidate points;

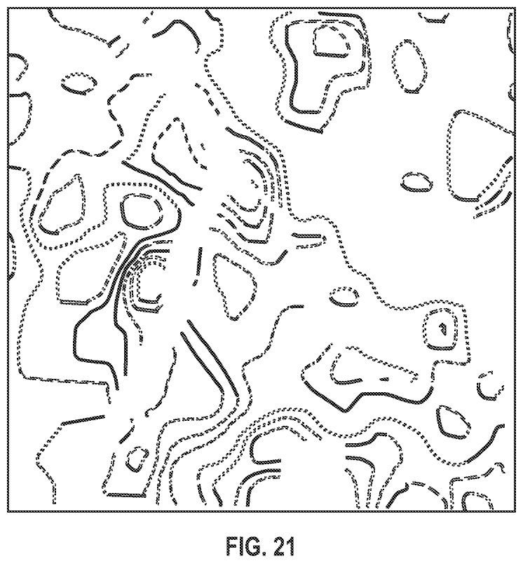

7. Intersect the cleaned-up cluster contours with the field boundary to obtain the cluster contour lines that fall within a field or a field part (for multipart fields). These cleaned, smoothed and split cluster contour lines are the candidates for use as one or more farming reference lines for use in performing a farming operation on the field or field part. The cluster contours that are closed (loop), nearly closed (three sides of a loop), or excessively winding are preferably split. This is done because such lines are not ideal for field design nor path planning. In one embodiment, cluster contour lines are preferably split by ranking candidate points on the enclosing convex hull by Menger curvature. First, small, closed cluster contour lines are dropped, then the convex hull of the points on the cluster contour line is created (using a common implementation of a convex hull generating algorithm—for example Chan's algorithm). Points intersecting the convex hull and the cluster contour line are preferably ranked using Menger curvature with spacing 2. FIG. 21 illustrates cluster contour lines that have been split using foregoing above workflow wherein each of the different line types represent a split part of the cluster contour line.

8. Rank the resultant split cluster contours for each field part with the goal of obtaining long lines that have the highest average elevation change on opposing sides of them and are not close to each other. Length, the maximum gradient along and across the cluster contour line, and the proximity between cluster contour lines is captured for ranking. Cluster contours are preferably ranked using these properties in the following order: Length (long is favored), proximity (close and similar cluster contours are discouraged), maximum gradient along a cluster contour line (small gradients are favored), and maximum gradient on opposing sides of a contour line (large gradients are favored).

9. Return the top-ranked reference lines for each field part. The number returned can optionally depend on an amount selected or otherwise provided by a user.

10. If a reference line completely falls within the field boundary and does not intersect it, a line extension algorithm is preferably used to reach the field boundary. In the line extension algorithm, each reference line has two ends. In one embodiment, two points can be chosen on each end and the reference line can be extended in the direction determined by these points. For curved lines, because a curve is a collection of points joined by straight line segments, to extend the curve, the two line segments at the two ends of the curve are preferably selected. Then, the slopes of the two line segments are determined. The point of intersection with the field boundary of the infinite straight line passing through each end segment is then found. Then, each segment is extended to the respective point of intersection.

11. Optionally, different smoothing options can be provided to a user to smooth and simplify the lines. For example, three or more levels of smoothing can be provided and a user can select the desired amount and can view the effect of each selection. For example, in one embodiment, a first level of smoothing can use quadratic Bezier curves and follow the reference line closely. A second level of smoothing can introduce circular arcs within quadratic Bezier curves to ensure steerability at pinch points and sharp turns. The result deviates from the original reference line at sharp turning points. A third level of smoothing can build a trend line for the points on the reference line using cubic regression. The reference line is preferably rotated in different orientations to determine the optimal orientation for a regression line. The regression line can deviate significantly from the original reference line, but the regression line preferably provides a simple geometry with high steerability. In one embodiment, a default level of smoothing can optionally initially be applied.

12. The resulting smoothed reference lines are preferably used in field design or path planning. For field design, the user can have the option to decompose the field using one or more of these lines. For multipart fields, the user can optionally further decompose them into additional parts.

13. For path planning of an existing field, the reference curve is preferably orthogonally projected in both directions by the track width. Tracks are preferably extended and clipped to the headland or the field boundary as needed. Optionally, these tracks can be joined—for example with a turn at the headland or on a road surrounding the field to produce a path. Tacks can continue to be projected until they cover the field. Coverage can be determined by generated track swaths (polygons) around the track lines. Tracks are preferably no longer generated when track swaths have covered the field area. In some areas, roads or pathways are often provided around the fields. In these areas, a farmer can continue on their path all the way to the end of the field and can turn for the next row in the road or path. For areas that do not have a road or path disposed around a field, the farmer can plan one or two headland passes around the boundary of the field and run the curves up to the headland where they then make their turn for the next row.

14. To maintain steerability, the user can optionally apply any of a predetermined amount of soothing levels to track lines, or can be provided with another option for adjusting the amount of smoothing that is applied, for example via a slider or dial or user-entered quantity. A default amount, which can be a predetermined amount, of smoothing can optionally be applied. Optionally, the reference line can be smoothed by a predetermined amount or by a user-determined or user-selected amount. In one embodiment, the reference line can be smoothed aggressively so that the resulting tracks do not need much smoothing.

15. The user can optionally introduce one or more headland passes (perimeter passes around the field boundary and obstacles) that create looping tracks around the field boundary (exterior passes) and/or around the obstacles (interior passes). This is usually done to create turning space for machines when they reach the field boundary or an obstacle. The algorithm then preferably generates the tracks to only cover the remainder of the field area (interior area), such that the tracks are clipped at the edge of the headland passes.

16. Whether headlands are used or not, the curved tracks generated are extended to ensure full coverage of the field. This is a different line extension algorithm than the one used in step 11. Path planning algorithms are based on track centerlines, but the actual machine track is a rectangle that may hit the headland or field boundary at any angle. Thus, the track centerline may reach the headland/boundary while one of the sides of the rectangular track lag behind resulting in missing coverage. Hence, a line extension algorithm was developed to successfully address this issue. An example of one such algorithm that can be used includes:

A. Buffer the track line by the swath width to generate a swath (2D machine track) centered at the track line (the two curves of the polygon parallel to the track line are referred to as the “sides” of the swath).

B. The swath has two ends corresponding to the ends of the track line where it intersects the headland and/or field boundary. The ends are line segments orthogonal to the track line and the sides.

C. At each end, determine if a side lags behind the track line. No side lags behind if the track hits the headland and/or field boundary orthogonally.

D. Extend the lagging side to the headland and/or field boundary using the line extension algorithm previously described. This adds a new point to the side.

E. Draw a line orthogonal to the extended side and passing through the added point.

F. Extend the other side and the track line to the orthogonal line using the line extension algorithm previously described.

G. Repeating C-G at each end generates a new extended track line and swath.

17. Each of the generated tracks is preferably split into segments having a selected length (which in one embodiment preferably has a length of about 30 m or less). The magnitude of the length that is selected can be chosen based on a user's preferences. For example, a user may optionally choose 30 m because the resolution of the NASADEM raster used may be 30 m×30 m. 30 m leads provide results that are found to be efficient. Higher lengths may result in fewer segments and lose slope change information. Smaller lengths may require more computational power. However, a longer or shorter length can optionally be chosen. Note that by “a length of about 30 m or less” we mean that we traverse the curve and insert a point about every 30 m if a point doesn't already exist. A curve may have points/vertices that are closer than 30 m in which case we don't add intermediate points. After the generated tracks are split into segments of a selected length, slope, 3D length, and a quantity that represents soil erosion (“LS”) is preferably computed for each segment. The results are aggregated and returned to the user. The algorithm and/or the user can decide the best reference line and path plan based on user criteria (minimize soil loss, minimize distance, minimize high slope segments, a combination thereof and the like). After computing LS for each segment, all LS values are preferably added together to compute the aggregate LS value. Determine the slope length and grade for the longest slope and the steepest slope on the property. Compute the LS factor using the formula below.

$$Equation for Calculating Slope Length - Gradient Factor also known as ( LS )$$

$$L S = {[ 0.065 + 0.0456 ( slope ) + 0.006541 {( slope )}^{2} ] [ \frac{slope length}{72.5} ]}^{NN}$$

Where: slope=slope steepness (%)
   Slope length=length of slope (ft.)
   NN=see table below
Determining the NN value for (LS)

| | | Equal to or | Equal to or | |
|---|---|---|---|---|
| | | greater | greater | |
| | | than 1% but | than 3% A | |
| Slope | | less than | but less | |
| Steepness | Les than 1% | 3% | than 5% | 5% or greater |
| NN | .2 | .3 | .4 | .5 |

18. All the above is equally applicable if the reference line is a straight line and hence the path plan consists of straight lines. Note that the foregoing equation for calculating slope length-gradient factor (LS) is only one example of an LS calculation that can be used. In the foregoing calculation, the coefficients 0.065 etc. comes from trigonometric calculations. There are other variants available that can also be used. However, the results were found to remain fairly consistent with either variant. LS is preferably computed for each segment (for example each segment which can be 30 m or less in length).

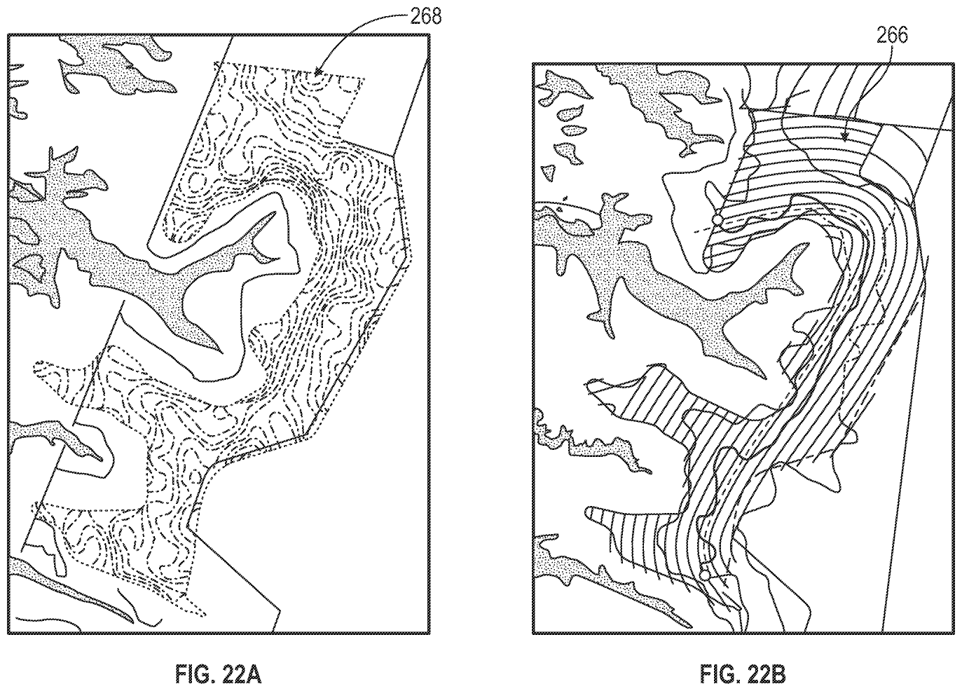

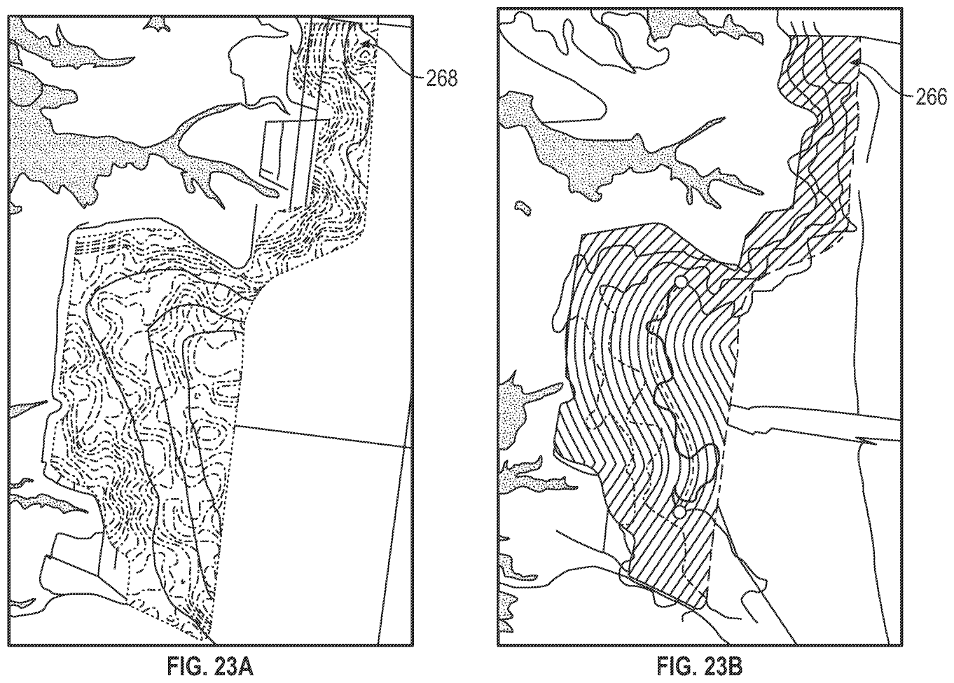

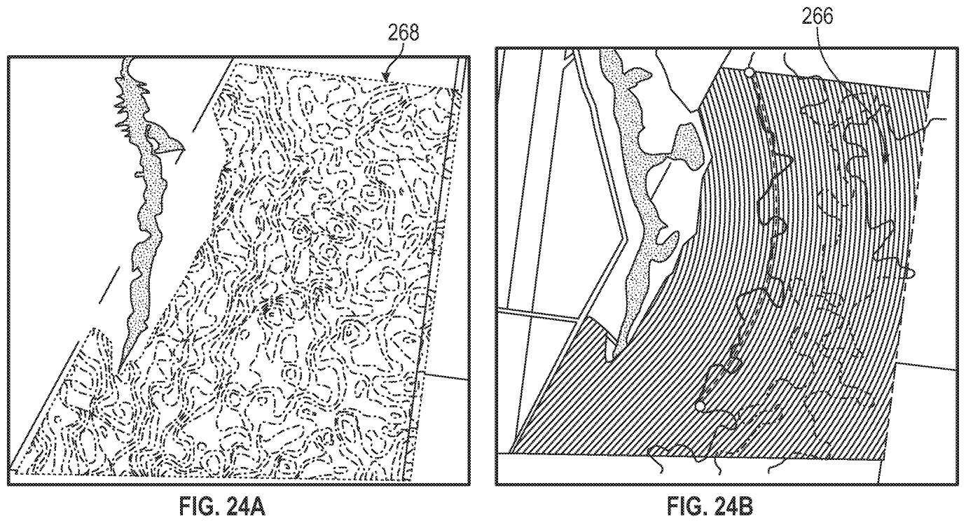

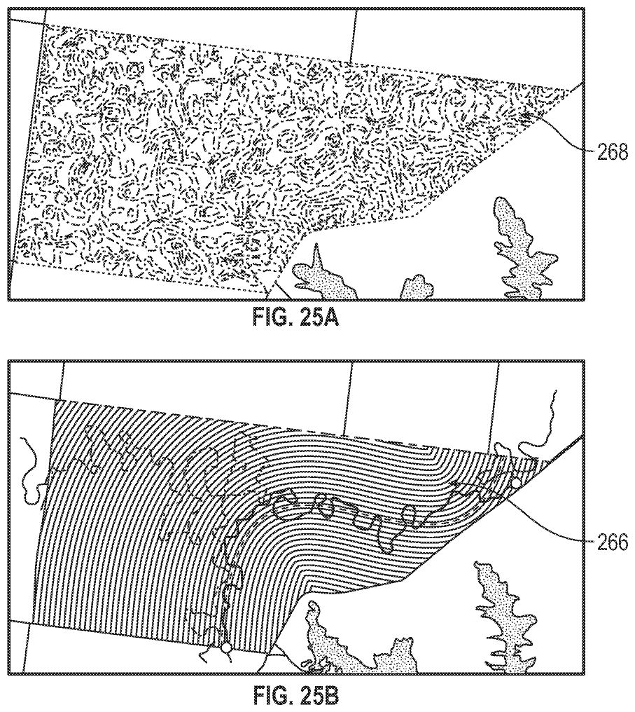

FIGS. 22B, 23B, 24B, and 25B, illustrate cluster contour extraction results 266 for four different plots of land where the maximum number of contours=3, and are ranked to favor length of the cluster contour and to have a small max elevation change on opposing sides of each contour. The maximum number of cluster contours (for example 3) is an upper limit on the number of cluster contours produced by the algorithm. The algorithm may find less than 3, or more than 3, but 3 will be the maximum number of cluster contours in the output. FIGS. 22A, 23A, 24A, and 25A show the respective 1 meter (“m”) elevation contour maps (SECs) 268 for each of those.

One parameter that is preferably used is the target number of clusters for the clustering algorithm. In one embodiment, this can be selected automatically by using an algorithm which determines the target number of clusters based on the histogram of point elevations in the field. The target number of clusters is preferably selected based on a maximum of about 20 iterations of k-means (with a fixed random state) to minimize penalized scaled inertia (a distance between each data point and its cluster center, which is preferably scaled based on the inertia of the dataset using a single cluster). Scaled inertia is preferably penalized by using an additional term dependent on k and the total elevation difference in the raster. K-means is preferably used to separate elevation values into clusters with the previously found k value, and a fixed random state. The following equation can be used to determine the number of target clusters:

$$arg {min}_{k} ( \frac{{δ}_{k}}{{δ}_{1}} + \frac{k αΔelevation}{S} )$$

k=Number of clusters
δₖ=Inertia for value of k∈[2,20]
δ₁=Baseline inertia value with single cluster
α=Tuning constant∈(0,1)
Δelevation=Elevation difference across raster
S=Product of number of rows and columns in raster data

Optionally, in one embodiment, off the shelf (“OTS”) single-elevation contours can be used instead of contours produced by the previously described clustering method. In this embodiment, the rest of the smoothing and path planning method and apparatus remains the same. OTS contours can optionally be accessed via APIs or purchased in bulk and stored in a database.

In one embodiment, smoothed cluster contour lines can be uploaded by the grower or another user. For example, growers in Brazil can obtain cluster contours from technicians and consultants who perform extensive manual analysis using CAD based tools. In one embodiment, the present invention preferably does not simply rely on single elevation contours as an output for a path plan.

Optionally, cluster contours and single elevation contours can be generated mathematically (instead of using machine vision) directly from the point data (x, y, z coordinates). This can be an alternative contour finding algorithm in an implementation of the contour generation suite.

Optionally, other approaches can be used for smoothing cluster contours and path plans. Examples include using polynomial curves (preferably polynomial curves having a degree of 3 or higher, rather than cubic polynomial curves for regression, replacing Bezier curves with circular arcs or other types of curves, and smoothed curve generation under steerability constraints.

Although embodiments of the present invention are particularly for designing and path planning of agricultural fields, the embodiment of the present invention are not limited to agricultural path planning. Instead, embodiments of the present invention can be used for any instances wherein a robot, a vehicle, or user wishes to travel on parallel curved tracks to cover a region. Generating cluster contours and using them for path planning can allow a user to reduce the 3D distance traveled by the robot, user, or vehicle, as well as use different curved tracks in different subregions based on elevation features. This general problem can be called “Coverage path planning for vehicles and robots on a 3D surface”.

An embodiment of the longest straight edge and/or cluster contours is not performed while a piece of equipment is in operation and does not gain data for an agricultural field by collecting the data from on-site sensors nor from sensors mounted or a tractor. In one embodiment, the present invention can produce a path plan for an entire agricultural field and does not do so with respect to a current location of a tractor or other piece of equipment and does not reference or require knowledge of a location of a piece of equipment. In one embodiment, the path plan is not generated in real-time with concurrent with a farming operation taking place. An embodiment of the present invention can produce a path plan without requiring a piece of farming equipment to travel to or traverse over any portion of an agricultural field.

In one embodiment, if data about an agricultural field is collected by a piece of farming equipment, the data is preferably processed after the farming operation and not in real-time with the farming operation. An embodiment of the present invention preferably uses specifications for equipment contained in a database as inputs for a path planning operation. In one embodiment, the present invention preferably uses a boundary around low areas (for example creeks or ponds) as a reference line for path planning. In one embodiment, the present invention preferably performs path planning for an agricultural field before the equipment being considered for the path has started a farming operation in the field. Thus, in one embodiment, path planning is a separate step from the act of actually performing a farming operation and is preferably performed before the act of actually performing a farming operation is undertaken. In one embodiment, after the path plan, which can be formed by clustered contours or by using the longest straight edge has been created, the path is applied to the agriculture filed by the farming equipment—operationally the path can be applied automatically by the farming equipment. Thus, the farming equipment can perform the path plan.

The preceding examples can be repeated with similar success by substituting the generically or specifically described components and/or operating conditions of embodiments of the present invention for those used in the preceding examples.

Optionally, embodiments of the present invention can include a general or specific purpose computer or distributed system programmed with computer software implementing steps described above, which computer software may be in any appropriate computer language, including but not limited to C, C++, FORTRAN, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices. Embodiment of the present invention can be provided as software as a service.

The terms, “a”, “an”, “the”, and “said” mean “one or more” unless context explicitly dictates otherwise. Note that in the specification and claims, “about”, and “approximately”, means within twenty percent (20%) of the amount, value, or condition given. The term “substantially” means within ten percent (10%) of the amount, value, or condition given. All computer software disclosed herein may be embodied on any non-transitory computer-readable medium (including combinations of mediums), including without limitation CD-ROMs, DVD-ROMs, hard drives (local or network storage device), USB keys, other removable drives, ROM, and firmware.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and this application is intended to cover, in the appended claims, all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A method for evaluating farming equipment on a physically tangible agricultural field without requiring a user to actually operate the equipment on the physically tangible agricultural field, the method comprising:
providing field data representing actual geographic conditions for the physically tangible agricultural field on which a farming operation is to be performed;
providing specifications of existing farming equipment;
using the provided specifications and the provided field data to determine a first optimized path plan for the existing farming equipment on the physically tangible agricultural field;
retrieving specifications for at least one piece of other farming equipment from an equipment database;
using the retrieved specifications and the field data to determine a second optimized path plan for the at least one piece of other farming equipment on the physically tangible agricultural field;
calculating at least one of optimized path distance and optimized path travel time for the existing equipment on the first optimized path plan;
calculating at least one of optimized path distance and optimized path travel time for the at least one piece of other farming equipment; and
reporting results of a comparison between at least one of:
the optimized path travel time for the existing equipment and the at least one piece of other farming equipment; and
the optimized path distance for the existing equipment and the at least one piece of other farming equipment.

2. The method of claim 1 wherein providing field data comprises providing field data representing at least a shape and size of the physically tangible agricultural filed.

3. The method of claim 1 wherein providing field data comprises providing data from a satellite image of the physically tangible agricultural field.

4. The method of claim 1 wherein providing specifications of existing farming equipment comprises selecting at least some of the existing farming equipment from the equipment database.

5. The method of claim 1 wherein retrieving specifications for at least one piece of other farming equipment further comprises retrieving specifications for at least some portion of the existing farming equipment.

6. The method of claim 5 further comprising adjusting performance characteristics for the at least some portion of the existing farming equipment based on the retrieved specifications for the at least one piece of other farming equipment.

7. A farming method for a physically tangible agricultural field, the method comprising:
obtaining data representing at least a boundary of the physically tangible agricultural field;
extracting line segments from boundary polygons of the obtained data;
computing headings for the extracted line segments;
clustering the line segments into a plurality of clusters based on the computed headings;
ranking the plurality of clusters based on total length of line segments contained in each cluster; and
reporting a heading for farming equipment to use to perform a farming operation, the heading associated with a line of best fit for a cluster having a largest total length of line segments.

8. The method of claim 7 wherein clustering the line segments according to the computed headings comprises clustering the line segments according to computed headings with a heading threshold such that each line segment in a cluster need not have numerically identical heading values.

9. The method of claim 8 wherein the heading threshold can be user-defined.

10. The method of claim 8 wherein the margin of error is such that line segments within a cluster have headings that differ from one another by not more than 3 degrees.

11. The method of claim 7 wherein reporting a heading associated with line segments comprises reporting a heading comprising an average of headings for all line segments for the cluster having the largest total length of line segments.

12. The method of claim 7 further comprising causing farming equipment to travel in a heading that is at least substantially equal to a heading of at least one of the line segments contained in the cluster having the largest total length of line segments.

13. The method of claim 7 further comprising causing a piece of farming equipment to travel in a heading that is at least substantially equal to a heading of at least one of the line segments contained in the cluster having the largest total length of line segments to perform a farming operating.

14. The method of claim 7 further comprising reporting a heading associated with line segments for a cluster having a second largest total length of line segments.

15. The method of claim 14 further comprising selecting a heading associated with either the cluster having the largest total length of line segments or a heading associated with a cluster having a second largest total length of line segments and using the selected heading for planning a path for a farming equipment.

16. The method of claim 7 further comprising dividing at least some of the plurality clusters into a plurality of smaller clusters based on a distance threshold.

17. The method of claim 7 wherein reporting a heading associated with line segments comprises calculating a regression line or line of best fit for line segments in the cluster having the largest total length of line segments

18. The method of claim 7 further comprising generating a path plan for the physically tangible agricultural field based at least in part on a multi-line string that includes a plurality of parallel line strings having a heading that at least substantially corresponds with the reported heading.

19. The method of claim 18 wherein generating a path plan for the physically tangible agricultural field further comprises:
obtaining as inputs at least one of specifications of the agricultural equipment;
obtaining a number of perimeter passes inside an exterior boundary of the physically tangible agricultural field; and
avoiding boundaries of obstacles that are disposed at least partially within a perimeter of the physically tangible agricultural field.

20. The method of claim 7 wherein obtaining data representing at least a boundary of a physically tangible agricultural field comprises obtaining satellite image data of the physically tangible agricultural field.

21. A farming method for a physically tangible agricultural field, the method comprising:
obtaining raster data representing at least a boundary of the physically tangible agricultural field;
clustering elevation data into a plurality of different clusters;
creating cluster contour lines between the plurality of different clusters by detecting and extracting the cluster contour lines;
ranking the created cluster contour lines based on at least one of:
length;
maximum gradient along a length of the respective cluster contour line; and
maximum gradient on opposing sides of the respective cluster contour line;
selecting at least one of the cluster contour lines from the ranked cluster contour lines;
generating tracks by offsetting each of the smoothed selected at least one cluster contour lines;
smoothing the generated tracks to maintain steerability of the farming equipment when operating on the physically tangible agricultural field; and
performing slope-distance analysis on the smoothed tracks to estimate at least one of:
anticipated soil erosion that will be caused by the farming equipment when operating on the physically tangible agricultural field; and
distance that will be traveled by the farming equipment when operating on the physically tangible agricultural field.

22. The method of claim 21 further comprising partitioning the physically tangible agricultural field into at least a first subfield and a second subfield based on at least one top-ranking cluster contour.

23. The method of claim 22 further comprising generating a first path plan for the first subfield and generating a second path plan for the second subfield.

24. The method of claim 21 further comprising cropping the contours along a boundary of the physically tangible agricultural field.

25. The method of claim 21 further comprising upsampling the raster data by interpolation.

26. The method of claim 25 wherein upsampling the raster data by interpolation comprises upsampling the raster data by cubic spline interpolation.

27. The method of claim 21 wherein detecting and extracting the cluster contour lines comprises using a machine vision algorithm.

28. The method of claim 27 wherein the machine vision comprises a Canny edge detection algorithm.

29. The method of claim 21 wherein after extraction and prior to ranking, the cluster contour lines are cleaned to remove zig-zag and chain-line features by smoothing the contour lines along such features.

30. The method of claim 29 wherein smoothing the cluster contour lines along such features comprises simplifying the cluster contour lines along such features by using a topology-preserving Douglas-Peucker simplification and then smoothing the cluster contour lines using a Taubin non-shrinking polyline smoothing function.

31. The method of claim 21 further comprising splitting cluster contour lines that are closed loops or have at least 270 degrees of closure.

32. The method of claim 21 wherein selecting at least one of the cluster contour lines comprises selecting at least one cluster contour line having a ranking that places it in the top 10% of ranked cluster contour lines.

33. The method of claim 21 wherein generating tracks by offsetting each of the selected at least one cluster contour lines comprises generating tracks by offsetting each of the selected at least one cluster contour lines after the selected at least one cluster contour lines have first been smoothed.

34. A farming method for a physically tangible agricultural field, the method comprising:
providing field data representing actual geographic conditions for the physically tangible field on which a farming operation is to be performed, wherein providing field data comprises:
obtaining raster data representing at least a boundary of the physically tangible agricultural field;
clustering elevation data into a plurality of different clusters;
creating cluster contour lines between the plurality of different clusters by detecting and extracting the cluster contour lines;
ranking the created cluster contour lines based on at least one of:
length;
maximum gradient along a length of the respective cluster contour line; and
maximum gradient on opposing sides of the respective cluster contour line;
selecting at least one of the cluster contour lines from the ranked cluster contour lines;
generating tracks by offsetting each of the smoothed selected at least one cluster contour lines;
smoothing the generated tracks to maintain steerability of the farming equipment when operating on the physically tangible agricultural field;
returning the smoothed generated tracks as at least a portion of the field data;
providing specifications of existing farming equipment;
using the provided specifications and the provided field data to determine a first optimized path plan for the existing farming equipment on the physically tangible field;
retrieving specifications for at least one piece of other farming equipment from an equipment database;
using the retrieved specifications and the field data to determine a second optimized path plan for the at least one piece of other farming equipment on the physically tangible field;
calculating at least one of optimized path distance and optimized path travel time for the existing equipment on the first optimized path plan;
calculating at least one of optimized path distance and optimized path travel time for the at least one piece of other farming equipment, and
reporting results of a comparison between at least one of:
the optimized path travel time for the existing equipment and the at least one piece of other farming equipment; and
the optimized path distance for the existing equipment and the at least one piece of other farming equipment.
